(19) United States
(12) Patent Application Publication
(10) Pub. No.: US 2016/0186097 A1
(43) Pub. Date: Jun. 30, 2016

(54) FUGITIVE DYE CATCHING MATERIAL

(71) Applicant: AHLSTROM CORPORATION, Helsinki (FI)

(72) Inventors: Diego FANTINI, Pont-Evêque (FR); Samuel MERLET, Vaulnaveys le haut (FR)

(73) Assignee: AHLSTROM CORPORATION, Helsinki (FI)

(21) Appl. No.: 14/910,834

(22) PCT Filed: Aug. 11, 2014
(86) PCT No.: PCT/FI2014/050616

§ 371 Date: Feb. 8, 2016

(30) Foreign Application Priority Data
Aug. 9, 2013 (EP) 13179996.7

(51) Int. Cl. C11D 3/00; C11D 3/37; C11D 17/04

(52) U.S. Cl. CPC C11D 3/0021; C11D 17/049; C11D 3/3753; C11D 3/3719; C11D 3/3788; C11D 3/3776; C11D 3/3723

(57) ABSTRACT

A dye-receiving material comprising:a support comprising synthetic fibers; and a three-dimensional network entangled with at least some of the fibers contained in the support. The three-dimensional network comprises a first polymer that is cross-linked by a second polymer; wherein the first polymer is a polyamine comprising primary amine groups, the first polymer being cationic and water soluble; and the second polymer is a water soluble polymer that is different from the first polymer. The second polymer containing repeating units comprising halohydrin and/or epoxide groups that are capable of forming covalent cross-links with the primary amine groups of the first polymer. Low amounts of cross-linking components are needed for high dye pick-up efficiency.

### TECHNICAL FIELD

The present invention relates to a laundry aid that is capable of capturing dyes from aqueous media, and uses thereof. For example, the present invention encompasses using the laundry aid to capture dyes from wash liquor during the laundering of items from which dyes may leach, such as textiles. Further aspects of the present invention include more complex products that incorporate the laundry aid and efficient processes for producing the laundry aid.

### BACKGROUND ART

Manufacturers of everyday items tend to color their products in order to improve consumer appeal. For example, automobile manufacturers typically include pigments in the bodywork paint so that the bodywork is both protected from the elements and aesthetically pleasing. Manufacturers of fabrics, such as tablecloths and clothing, typically add dyes to their fabrics so that the end product is aesthetically pleasing to the consumer. However, consumer appeal diminishes over the lifetime of the product if the initially pleasing color deteriorates. This is a particular problem with household fabric products because laundering colored fabrics in order to remove dirt can also remove dye compounds by causing them to leach into the wash liquor from the fabric.

The leaching of dyes into the wash liquor creates further problems because dyes leaching from one fabric can discolor other fabrics present in the same wash liquor. For example, simultaneously laundering a red fabric and a white fabric can lead to the white fabric being discolored due to it absorbing dye that has leached from the red fabric. One approach to this problem is to periodically bleach discolored white fabrics, but the use of bleach is a harsh process that can bring about the premature degradation of fibers. Moreover, bleaching itself discolors non-white fabrics, and so bleaching cannot be used with fabrics that include both white and colored portions. An alternative approach is to only wash like-colored fabrics together, but this is an inconvenient and time-consuming solution to the problems caused by dyes leaching into wash liquor.

The laundry industry has attempted to address this issue by devising laundry aids that are designed to capture the dyes that have leached out of fabrics and into the wash liquor before they dye other fabrics. Typically, these laundry aids are provided in the form of a woven or non-woven cloth or fabric that is insoluble in the wash liquor, and which is equipped with a chemical treatment that can capture dyes in order to prevent the dyes from dying other fabrics. The mechanism by which the dye-capture chemical operates is not particularly limited. It can, for instance, be capable of forming covalent bonds with dye compounds diffusing through the wash liquor. Alternatively, the chemical treatment can capture dyes by forming strong intermolecular interactions, such as ionic interactions, with dye compounds.

For example, EP-A-1 889 900 reports a detergent article comprising a flexible carrier, such as a nonwoven fabric, and a dye-scavenger component in the form of an imidazole-epichlorohydrin copolymer. The imidazole-epichlorohydrin copolymer is selected as the dye-scavenger because it is believed that this particular polymer is also able to adsorb strongly to the flexible carrier and is therefore less likely to disassociate from the detergent article during a laundering operation. Accordingly, the detergent article of EP-A-1 889 900 lacks versatility because it requires a very particular dye-scavenging copolymer. It is also not clear whether the strong physical adsorption attributed to the imidazole-epichlorohydrin copolymer is independent of the flexible carrier, which further points to a lack of versatility.

An alternative approach is to directly bond the dye-capturing species to the substrate. For example, it is reported in WO-A-2008/138574 that cellulose can be reacted with glycidyl trimethylammonium chloride (GMAC) to form cellulose derivatives containing quaternary ammonium groups, as shown below:

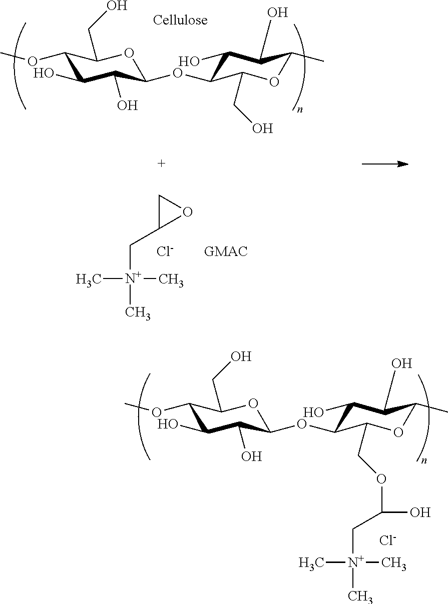

However, this type of reaction is known to proceed slowly, and so it can be necessary to remove unreacted GMAC after the reaction due to its hazardous nature. Removing GMAC from the crude product is, moreover, a challenging step, which further complicates the process.

A method of manufacturing laundry additive article is disclosed in US2003/0118730. The document describes a laundry aid that catches dyes from aqueous wash liquor and retains the dye securely after capture. This dye or soil absorber is cross linked on a substrate that is fixed. The materials for achieving dye absorption may be formed from amine containing molecules cross linked with reactive groups.

A number of problems remain. In particular, a versatile dye- catching laundry aid that efficiently catches dyes from aqueous wash liquor and retains the dye very securely after capture has thus far proved elusive.

It would also be highly beneficial if such a laundry aid could be produced using a cost-effective, rapid and efficient process that avoids hazardous chemicals. For example US2003/0118730 teaches a 2-stage application process in which a cross-linker is first added and then the dye or soil absorbent in order to avoid viscosity issues. A high coating load of 60 to 113 g/m² is further taught; a product thus obtained will not only be expensive but will also exhibit properties of high stiffness and low permeability.

These and others needs are addressed by the present invention.

### SUMMARY OF THE INVENTION

The present invention addresses these and other needs by providing a dye-capturing laundry aid comprising:
a support in the form of a sheet comprising water insoluble fibers; and
a three-dimensional network entangled with at least some of the fibers contained in the support, the three-dimensional network comprising a first polymer that is cross- linked by a second polymer; wherein:
the first polymer is a polyamine comprising primary amine groups, the first polymer being water soluble and cationic; and
the second polymer is a water soluble polymer that is different from the first polymer, the second polymer containing repeating units comprising halohydrin and/or epoxide groups that are capable of forming covalent cross-links with the primary amine groups of the first polymer; and
optionally wherein titration of a pH 6.5 aqueous composition that has been obtained by immersing 50 g of the laundry aid in one liter of water at 70° C. for 10 minutes requires ≦3 mmol of NaOH to raise the pH of the aqueous composition from 6.5 to 10.5 at 25° C.

As will be discussed below, this material is highly effective at capturing and then firmly retaining dye compounds by virtue of the strong affinity between dye compounds and the first and, optionally, second polymers in the three-dimensional network entangled with the support fibers. The present invention is therefore well-suited to capturing dye compounds from aqueous media, such as the wash liquor used in a laundering process.

Moreover, since the first and second polymers are securely held within the laundry aid by virtue of being entangled with the support fibers, the captured dye compounds are held firmly in place by being indirectly bound to the support fibers. Accordingly, dye compounds captured during a laundering process are held firmly in place by the laundry aid, rather than allowing the dye compounds to dissociate from the laundry aid and cause unwanted color runs.

A further unexpected advantage of the laundry aid is that the three-dimensional network confers surprisingly good structural integrity to the laundry aid, meaning that the laundry aid can easily withstand the tumbling motion of a laundering process without breaking up. This is a significant advantage over traditional laundry aids, which normally require the addition of a binder material in order to confer such structural integrity.

As there is no need for the three-dimensional network to be chemically bonded to the support fibers, a greater variety of support fibers can be used in conjunction with the present invention. Traditional laundry aids have required direct chemical bonding between the support and the dye-capturing molecules, but this precludes chemically inert support fibers, such as polyalkenes. The present invention can tolerate such chemically inert fibers, meaning that the user benefits from increased versatility in this respect.

Compared to laundry additive articles disclosed in the art, the present invention provides products having high dye capture efficiency for which reason already light coatings will give satisfactory efficiency. Low-grammage coatings will give flexibility of the coated product and good permeability.

A further advantage of the present invention is that the laundry aid can be readily produced in an efficient, versatile, cost-effective and environmentally friendly manner.

In fact, as shown by the test discussed below (cf. in particular Example 10), the present technology using polymeric primary amine leads to an efficient treatment rendering properties of insolubility while still requiring merely low amounts of cross-linker. Further, the use of polymeric primary amine makes it possible to achieve single-step application modes. The use of polymeric primary amine also leads to good material performances (e.g. in terms of DPU, Tensile, Whiteness, and Flexibility) with low treatment amounts. Thus, good material performances are attained at low costs.

### BRIEF DESCRIPTION OF DRAWINGS

FIG. 1: A) titration curves of 1 liter solutions of a polyvinylamine having an average molecular weight of 340,000 (wherein <10% of the amine groups are capped with formyl groups) at 1.73 g/l; 0.867 g/l and 0.173 g/l. B) Calibration curve for the polyamine used in FIG. 1A and based on the experimental data displayed FIG. 1A.

FIG. 2: A) UV-Vis spectra of solutions containing 12.5 mg/l of Indosol Red BA P 150 with different concentrations of a polyvinylamine having an average molecular weight of 340,000 (wherein <10% of the amine groups are capped with formyl groups) (a: 0 mg/l; b: 1.2 mg/l; c: 6 mg/l; d: 12 mg/l). B) Comparison of UV-Vis spectra of standard solutions containing 12.5 mg/l of Indosol Red BA P 150 with different concentration of the polyvinylamine having an average molecular weight of 340,000 (wherein <10% of the amine groups are capped with formyl groups) (a: 0 mg/l and c: 6 mg/l [respectively equivalent to 0% and 2.5% for a media containing 4 g/m² of Lupamin 9095] with spectra of the washing solutions of samples (e: sample 18; f: sample 19; g: sample 2320 h: sample 21) containing 12.5 mg/l of Indosol Red BA P 150.

FIG. 3: Plot of dye pick-up vs. the ratio of chlorohydrin to (N—H) functional groups.

FIG. 4: Plot of dye pick-up vs. the ratio of chlorohydrin to (N—H) functional groups.

FIG. 5: A) Plot of dye pick-up vs. the ratio of chlorohydrin to (N—H) functional groups. B) Plot of dye pick-up vs. the ratio of chlorohydrin to (N—H) functional groups.

FIG. 6: Schematic illustration of the three-dimensional network entangling with a support fiber, wherein: the first polymer 1 and the second polymer 2 are mixed in FIG. 3A; the mixed first and second polymers are impregnated around the support fiber 3 in FIG. 3B; and the second polymer cross-links the first polymer in FIG. 3C by reacting with the amine groups la of the first polymer.

FIG. 7 shows the evolution of the solution viscosity with time for the various formulations studied in Example 10. The solution viscosity is measured using a Brookfield viscosimeter (model LVDE-E) equipped with a spindle type s61 at a rotational speed of 100 rpm and at a solution temperature of 22° C.

### DESCRIPTION OF EMBODIMENTS

### Definitions

Average molecular weight: unless stated otherwise, ‘average molecular weight’ denotes number average molecular weight.

Average: unless stated otherwise, the term ‘average’ denotes mean average.

Weight/Mass: references to amounts ‘by weight’ are intended to be synonymous with ‘by mass’; these terms are used interchangeably.

Polymer: a compound comprising upwards of ten repeating units such as, for example, a homopolymer, a copolymer, a graft copolymer, a branch copolymer or a block copolymer.

### Components of the Laundry Aid

As mentioned above, the laundry-capturing aid of the present invention comprises a support containing fibers, a first polymer and a second polymer. These and other features of the present invention are discussed in detail in the following sections.

### Fiber-Containing Support

The laundry aid comprises a fiber-containing support about which the three-dimensional of first and second polymer is formed. The type, nature and size of the support are not particularly limited, which is advantageous in terms of versatility. An important aspect of the present invention is that the support fibers do not need to chemically bond to either the first or second polymers. Instead, the three-dimensional network is held in place by being entangled between and around the numerous fibers of the support in the form of a complicated matrix of entangled fibers and polymer chains. This is beneficial because a wide variety of support fibers can be used. In particular, chemically inert fibers, such as polypropylene, can be used in the support.

Generally speaking, the support provides a scaffold on which to form the three-dimensional network. This tends to make the support easier to handle by the user, which further lends to the convenient use of the laundry aid. The support can also be helpful during the production process because it provides structural integrity by acting as a scaffold prior to the formation of the three-dimensional network.

The types of fibers found in the support are not particularly limited, and can be natural or synthetic. For the avoidance of doubt, the term ‘fiber’ denotes short cut or staple fibers, as well as filaments. The fiber is typically water insoluble, which enables it to act as an insoluble scaffold and thereby prevent the laundry aid from disintegrating during use in an aqueous medium. Examples of suitable fiber types include cellulose, viscose, lyocell, cotton, polyamide, polyalkenes such as polyethylene, polypropylene and polybutylene, polyesters such as polylactic acid and poly(alkylene terephthalate) and copolymers thereof. It is also envisaged that glass fibers/filaments can be used since the three-dimensional network does not need to covalently bond to the support fibers.

Particularly suitable fibers include cellulose, viscose, lyocell, polyalkenes, such as polyethylene and polybutylene, polyesters, a poly(alkylene terephthalate) and copolymers thereof. Sometimes it can be useful to use a fully synthetic substrate, in which case the fibers in the support can consist of polyalkene or polyester fibers or a mixture or copolymer thereof. The laundry aid can also accommodate a mixture of fibers, such as a mixture of cellulose and viscose.

There is no particular limitation on the diameters and lengths of the fibers incorporated in the support, partly because the three-dimensional network adapts to the shape of the fibers prior to cross-link formation. Instead, the diameters and lengths can be determined by the user based upon their knowledge of their art and depending upon the intended end use.

There is no particular limitation regarding the type of fibrous substrate that can be used for the invention, but suitable substrates can be a woven, knitted or nonwoven material.

Preferred substrates are synthetic polyolefin spunbond or meltblown nonwovens or combination of thereof.

Spunbond refers to a material formed by extruding molten thermoplastic material as filaments from a plurality of fine capillary spinnerets with the diameter of the extruded filaments then being rapidly reduced as described in, for example, in U.S. Pat. No. 4,340,563, U.S. Pat. No. 3,692,618, U.S. Pat. No. 3,802,817, U.S. Pat. No. 3,338,992, U.S. Pat. No. 3,341,394, U.S. Pat. No. 3,502,763 and U.S. Pat. No. 3,542,615. The shape of the spinnerets is not particularly limited, though it is usually circular. Spunbond fibers are generally not tacky when they are deposited onto a collecting surface. Spunbond fibers are generally continuous and have average diameters larger than 7 microns, more particularly, between about 10 and 20 microns.

Meltblown refers to a material formed by extruding a molten thermoplastic material through a plurality of fine die capillaries as molten threads or filaments into converging high velocity, usually hot, gas (e.g. air) streams which attenuate the filaments of molten thermoplastic material to reduce their diameter. The shape of the dye capillaries is not particularly limited, though they are usually circular. Thereafter, the meltblown fibers are carried by the high velocity gas stream and are deposited on a collecting surface to form a web of randomly dispersed meltblown fibers. Such a process is disclosed in, for example, U.S. Pat. No. 3,849,241. Meltblown fibers are microfibers which may be continuous or discontinuous, are generally smaller than 10 microns in average diameter, and are generally tacky when deposited onto a collecting surface.

A combination of spunbond and meltblown materials can be a laminate in which some of the layers are spunbond and some are meltblown such as a spunbond/meltblown/spunbond (SMS) laminate and others, as disclosed in U.S. Pat. No. 4,041,203, U.S. Pat. No. 5,169,706, U.S. Pat. No. 5,145,727, U.S. Pat. No. 5,178,931 and U.S. Pat. No. 5,188,885.

Spunbond or meltblown can be made from polypropylene, polyester, polyethylene, polyamide, or combinations thereof.

Spunbond can also be made of multi-component fibers. The multi-component fibers may be formed by methods, such as those described in U.S. Pat. No. 6,074,590. Generally, multi-component fibers are formed by co-extrusion of at least two different components into one fiber or filament. The resulting fiber includes at least two different essentially continuous polymer phases. In one non-limiting embodiment, the multi-component fibers include bicomponent fibers. Such multi-component spunbond fibers are particularly useful as heat sealable material.

Another preferred nonwoven substrate is a drylaid carded nonwoven consolidated either chemically, thermally or by mechanical entanglements. Examples of nonwoven with mechanical entanglements are needlepunched or spunlaced nonwovens that are created by mechanically orienting and interlocking the fibers of a carded web. Useful ways to obtain such nonwovens are disclosed in U.S. Pat. No. 5,928,973, U.S. Pat. No. 5,895,623, U.S. Pat. No. 5,009,747, U.S. Pat. No. 4,154,889, U.S. Pat. No. 3,473,205. The staple fibers are generally short fibers, such as in cotton, having a length of about 35 to 80 mm, or they can be short cut synthetic fibers having a length of about 35 to 80 mm, and size from about 1 to 30 decitex.

Another preferred nonwoven substrate is a wetlaid nonwoven. Wetlaid nonwovens are produced in a process similar to paper making. The nonwoven web is produced by filtering an aqueous suspension of fiber onto a screen conveyor belt or perforated drum. Additional water is then squeezed out of the web and the remaining water is removed by drying. Bonding may be completed during drying or a bonding agent, e.g. an adhesive, may be subsequently added to the dried web and then the web is cured. Techniques for wetlaying fibrous material are well known in the art as described in EP-A-0 889 151. Fibers used in wetlaying processes typically have a length from about 5 to 38 mm and a size from 0.5 to 17 decitex.

The fiber-containing support can be formed exclusively of fibers or other components can be added as required. For example, wet strength additives can be added in order to improve the structural integrity of the fiber-containing support.

The support is provided in the form of a sheet. For example, typical laundry aids are provided in the form of a cloth-like sheet that tumbles and deforms easily without breaking during the churning motion of a domestic washing machine. In particular, the fiber-containing support can be provided as a woven or non-woven sheet/web prior to the formation of the three-dimensional network of first and second polymers. The size of such a sheet is not particularly limited, and can depend upon the intended use, but a sheet having a length of 5-30 cm, a width of 5-30 cm and a thickness of <0.5 cm can often be satisfactory. The sheet can, moreover, be subsequently manipulated into the form of a block, sphere, cylinder, tube, torus, a porous sachet and so forth.

### First Polymer

The first polymer is a polyamine, which is to say that it is a polymer comprising repeating units that have amine groups. The person skilled in this technical field would therefore appreciate that a polymeric polyamine will contain a large number of amine groups, preferably containing upwards of 50 amine groups. For example, the first polymer can be a polymer in which all repeating units possess an amine group, such as a homopolymer of one amine-containing repeating unit, or a copolymer of plural repeating units each possessing an amine group. Alternatively, the first polymer can be a copolymer possessing amine groups in only some of its repeating units. Copolymers representing the first polymer can be a random copolymer, block copolymer or graft copolymer, for example.

The amine groups present in the first polymer can be primary amines, secondary amines, tertiary amines and/or quaternary ammonium groups, provided that at least some primary amine groups are present in the first polymer in isolation. Moreover, different repeating units of the first polymer can have different types of amines.

Without wishing to be bound by theory, it is believed that the amine groups serve at least two purposes. On the one hand, the amine groups can form covalent bonds with the second polymer (in the case of the primary and second amine groups), thereby aiding the formation of the three-dimensional network. On the other hand, amine groups are also highly useful groups in terms of capturing dye compounds, as will be discussed below. A multitude of amine groups in the first polymer is therefore preferable so that covalent bonds can be formed with the second polymer whilst ensuring that amine groups remain available to aid the capture of dye compounds.

The term ‘amine’ takes on its usual meaning of being a derivative of ammonia in which one, two or three of the ammonia hydrogen atoms has been replaced by a substituent such as an alkyl group. In the special case of a quaternary ammonium group, the three hydrogen atoms are replaced by four substituents, thereby resulting in a cationic tetravalent nitrogen atom. Needless to say, the term amine does not encompass groups that the skilled person would recognize as separate functional groups. For example, those skilled in this field will appreciate that amides, nitriles, sulfonamides, urethanes and soforth are not amines, and polyvinylformamides, poly(meth)acrylamides, poly(meth)acrylonitriles, polyamides, polyvinylsulfonamides and so forth are not examples of the first polymer. On the other hand, the first polymer can include repeating units stemming from monomers that would ordinarily form these non-amine polymers, such as vinylformamide, (meth)acrylamide, acrylonitrile, vinylsulfonamide and so forth, because the first polymer can include non-amine repeating units as mentioned above, provided that the polymer has the mandatory primary and/or secondary amine groups as well. Both primary (R—NH₂) and secondary (R—NH—R′) amine groups—with R and R′ representing a carbon covalent bond—can react with the halohydrin and/or epoxide group of the second polymer to form covalent bonds. Primary amine groups can react with two reactive groups of the second polymer, forming two covalent bonds, since a primary amine group has two labile hydrogens. Secondary amines have one labile hydrogen and can thus form only one covalent bond by reacting with the second polymer. Hence the potential reactivity between functional groups can be defined in terms of the number of labile hydrogen atoms on the nitrogen atom of the amine group (i.e. the number of reactive N—H functions). In other words, the number of reactive N—H functional groups corresponds to the number of possible covalent bond that the amine groups can form.

The number of moles of the (N—H) functional group can be calculated as follows: the number of moles of the (N—H) functional group is equal to the number of moles of secondary amine group+two times the number of moles of primary amine groups.

The first polymer is water soluble, wherein the water solubility of the first polymer is preferably >10 g/liter at 25° C., more preferably >40 g/liter at 25° C. The water solubility of the first polymer assists dye-capture and retention because water-solubility implies hydrophilicity, which aids the retention of hydrophilic dyes. Water solubility also aids the production of the laundry aid because the first polymer is conveniently handled in the form of an aqueous solution. Moreover, the resulting three-dimensional network tends to have a better structure when the first polymer is water soluble because, when placed in water, the water soluble polymer chains will tend to exist (by virtue of the swelling phenomenon) with a more open, elongate tertiary structure than polymer chains that are not water soluble, or only sparingly water soluble. The ‘open’ tertiary structure of the polymer chains is helpful because it means that the individual polymer chains are more likely to intertwine with the individual chains of the second polymer and the fibers of the support, thereby promoting the necessary entanglement. In contrast, impregnating the support with first polymer chains that have a closed, ball-like tertiary structure will not promote entanglement.

The first polymer is cationic, which is to say that it bears an overall positive charge in an aqueous medium at all pH values of from 6 to 9, i.e. the typical pH values encountered during the laundering of textiles, fabrics and so forth. The cationic character can stem from groups that have a positive charge irrespective of pH, such as a quaternary ammonium group, or it can stem from groups that do not have a permanent positive charge, but that do have a positive charge under the above conditions. For example, the mandatory primary amine groups of the first polymer can serve as the cationic group because primary amines tend to be protonated at a pH of 6-9. Positively charged groups are helpful for a number of reasons. In particular, the positively charged regions of the first polymer help to electrostatically capture the types of anionic dyes (sometimes called acid dyes in this technical field) that are typically used in the coloration of cloth items.

Examples of the first include polymer include poly(allyl amine), poly(ethylene imine), partially hydrolyzed poly(vinylformamide), polyvinylamide, chitosan and copolymers of these polyamines with any other type of monomers.

The average molecular weight of the first polymer in isolation can be at least 20,000, preferably higher than 100,000, wherein higher molecular weight polymers tend to improve both the structural strength of the laundry aid and its ability to capture dyes. The upper limit of the average molecular weight of the first polymer is not particularly limited, but is generally less than 5,000,000, preferably less than 1,000,000. First polymers having an average molecular weight below these values are preferable because aqueous solutions of these polymers are generally easier to handle, as they are not overly viscous.

The first polymer can also comprise side-chains having quaternary ammonium groups.

Adding side-chains that possess such cationic groups can be helpful because they augment the effects explained above regarding the general cationic groups of the first polymer. For example, side-chain quaternary ammonium groups can be obtained by conducting a graft-type reaction on the first polymer using glycidyl trimethylammonium chloride and/or 3-chloro-2-hydroxypropyl trimethylammonium chloride as grafting reactants. For example, these groups can be bonded to amine groups of the first polymer, provided that sufficient amine groups remain for cross-linking and for also capturing dyes. Generally speaking, it is preferable that less than 30% of amine groups of the first polymer are occupied with side-chains having quaternary ammonium groups.

This helps to retain a large number of uncapped amine groups for cross-linking and also helps to ensure that the viscosity of the first polymer does not increase to the extent that it is inconvenient to handle when producing the laundry aid.

Thus, a particular advantage of using polyamines having primary amine groups as first polymer component is that low amounts of cross-linking components are needed for high dye pick-up efficiency. At the same time, there is low loss of dye after washing.

Further details regarding the first polymer are provided below in the passages dealing with the laundry aid as a whole.

### Second Polymer

The second polymer is a water soluble polymer that is able to cross-link chains of the first polymer by forming covalent cross-links, which contributes to the structural integrity of the three-dimensional network. These properties, in turn, contribute to the stability of the three-dimensional network before during and after use. Before use, the longevity of the three-dimensional network is manifested in terms of a long shelf-life, for example, because the three-dimensional network will not deteriorate over time. The laundry aid will therefore perform adequately even after being stored for a prolonged period of time. The structural integrity is also beneficial during and after the use of the laundry aid because the laundry aid will not deteriorate and, ultimately, break apart under the mechanical and thermal stress caused by the churning motion of the heated water in a laundry operation. As will be discussed below, the cross-linking also helps to ensure that the three-dimensional network is insoluble in water.

The second polymer is able to form the necessary covalent cross-links because it contains halohydrin and/or epoxide groups. Halohydrin groups are characterized by the presence of a hydroxyl group and a halogen functional group on adjacent carbon atoms. The halogen can be any of fluorine, chlorine, bromine and iodine, for example.

Chlorohydrin groups are particularly useful halohydrins within the scope of the present invention because they are readily obtainable and readily form cross-links with the first polymer. For example, the chlorohydrin illustrated in the following Formula (I) can be used in the laundry aid of the present invention:

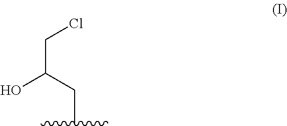 [SMILES: *CC(O)CCl]

wherein the zig-zag line indicates the point at which this chlorohydrin group is joined to the second polymer.

The mechanism by which the halohydrin groups, such as the one illustrated in Formula (I), form covalent cross-links with the first polymer is not particularly limited. In one mechanism, the halogen atom can be displaced by reaction with a nucleophilic group of the first polymer. In a related mechanism, the halohydrin groups can form an intermediate epoxide group via intramolecular nucleophilic attack by the hydroxyl group of the halohydrin group on the halogen group, and the newly-formed epoxide group can then react with nucleophilic groups of the first polymer.

Epoxide groups are characterized by the presence a three-membered cyclic ether. As a result of the ring-strain within the epoxide ring, epoxide groups tend to be more reactive than other cyclic ethers, which aids the formation of cross-links. For example, this ring strain can render the epoxide ring more labile towards nucleophilic attack from nucleophilic groups of the first polymer.

Whereas the first polymer can be characterized by the average number of N—H functional groups in its polymer chains, the second polymer can be characterized by the average number of halohydrin and/or epoxide functional groups in its polymer chains.

The average molecular weight of the second polymer in isolation is not particularly limited.

However, it is helpful if the average molecular weight is at least 1,000, preferably higher than 20,000, as this improves the structural integrity of the three-dimensional network within the laundry aid. Structural integrity can be manifested in terms of the tensile strength of the laundry aid. It is also helpful if the average molecular weight is lower than 5,000,000, preferably less than 1,000,000. Second polymers having an average molecular weight below these values are preferable because aqueous solutions of these polymers are generally easier to handle, as they are not overly viscous.

The second polymer is water soluble, wherein the water solubility of the second polymer is preferably >1 g/liter at 25° C., more preferably at least 3 g/liter at 25° C. The water solubility of the second polymer aids the production of the laundry aid because it is conveniently handled in the form of an aqueous solution. Moreover, the resulting three-dimensional network tends to have a better structure when the second polymer is water soluble because, when placed in water, the water soluble polymer chains will tend to exist (by virtue of the swelling phenomenon) with a more open, elongate tertiary structure than polymer chains that are not water soluble, or only sparingly water soluble. The open tertiary structure of the polymer chains is helpful because it means that the individual polymer chains are more likely to intertwine with the individual chains of the first polymer and the fibers of the support, thereby promoting the necessary entanglement of the various fibers and polymer chains present. In contrast, impregnating the support with second polymer chains that have a closed, ball-like tertiary structure will not aid entanglement. The mutual water solubility of both the first and second polymers is also helpful because the polymers will form favorable intermolecular interactions, which further promotes close intertwining and aids cross-linking.

The type of polymer used as the second polymer is not particularly limited, provided that it possesses the necessary halohydrin and/or epoxide groups. This versatility of the second polymer is yet another advantage associated with the present invention. Moreover, epoxide and/or halohydrin groups can be added to a pre-made polymer in a straightforward manner, which provides convenient access to a multitude of alternatives within the scope of the second polymer. For example, the halohydrin illustrated in Formula (I) above can be readily formed by reacting a polymer containing nucleophilic groups with epichlorohydrin.

Suitable types of polymers for use as the second polymer include polyamides, polyalkanolamines, polyamines fully reacted with halogen compounds such as epichlorohydrin, modified polydiallyldimethylammonium chloride, polyamines, polyalkenes, polyalkylene oxides, polyesters, poly(meth)acrylic acids) and copolymers thereof.

The second polymer can also comprise quaternary ammonium groups, which help to capture anionic dye compounds, such as acid dye compounds, that are typically used to dye fabrics. Such quaternary ammonium groups can, for example, be present in the polymer backbone, in the repeating units and/or in side-chains. The quaternary ammonium groups can be present in the same polymer chain as either the halohydrin groups or the epoxide groups mentioned above, or both the halohydrin groups and the epoxide groups; there is no particular limit in this regard. By way of an example, the second polymer can be a diallyl(3-chloro-2-hydroxypropyl)amine hydrochloride-diallyldimethylammonium chloride copolymer having the repeating units illustrated in following Formula (II):

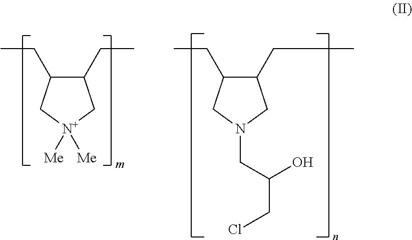

wherein the ratio of m:n in the polymer is in the range of from 1:9 to 9:1, preferably from 4:6 to 6:4. The average molecular weight is preferably higher than 1,000, more preferably higher than 20,000, and the average molecular weight is preferably lower than 5,000,000, more preferably lower than 1,000,000.

Further details regarding the second polymer are provided below in the passages dealing with the laundry aid as a whole.

### Further Components

In addition to the support fibers, first polymer and second polymer, the laundry aid material can include further components as desired by the user. For example, the user might choose to add a binder in order to aid structural integrity. Examples of binders include acrylics, vinyl esters, vinyl chloride alkene polymers and copolymers, styrene-acrylic copolymers, styrene-butadiene copolymer, urethane polymers, and copolymers thereof, wherein vinyl acetate and/or ethylene vinyl acetate copolymers are particularly useful. Preferably said binder is a self-cross-linkable binder, e.g. with pendant cross-linking functionalities. Preferably the binder is hydrophilic. The binder can also contain starch or polyvinyl alcohol. The amount of binder present, if desired by the user, can be generally in the range of from 5 to 50 g/m² of the surface of the laundry aid. However, the present invention does not explicitly require a binder because the entangled support fibers and three-dimensional network provides significant structural strength. This represents yet a further significant benefit of the present invention because traditional laundry aids normally require the addition of a binder in order to reach acceptable levels of structural strength.

The laundry aid can also contain heat-sealable components, such as a hot-melt adhesive, that allow the laundry aid to be heat-bonded. For example, the laundry aid can comprise thermoplastic fibers having melting temperatures less than 150° C. such as polyethylene or copolymers of polyesters, or bicomponent fibers possessing this capability. This enables portions of the laundry aid containing this component to be heat-bonded to another article and/or another portion of the laundry aid. For example, a sheet-like laundry aid can have a heat-sealable component around its perimeter, which enables the sheet to be heat-sealed to a similar sheet in order form a pouch or sachet. In a different approach, a sheet-like laundry aid can have a heat-sealable component around its perimeter can be folded in two and the corresponding portions having a heat-sealable component can be bonded together to form a pouch or sachet.

Additional components that can form part of the laundry aid include laundry detergents, antimicrobial components, bactericides, perfumes, brighteners, softeners, detergents, water-softening agent and/or surfactants, wherein the surfactants can, for example, be anionic, cationic, zwitterionic or nonionic. The amounts of these components present in the laundry aid are not particularly limited, and can, instead, be determined by the user according to their preferences.

### Laundry Aid

As mentioned above, the present invention is directed to a dye-capturing laundry aid comprising a fiber-containing support and a three-dimensional network of first and second polymers entangled with at least some of the fibers contained in the support, wherein the first polymer is cross-linked by the second polymer.

The mass ratio of the first polymer to the second polymer can be in the range of from 99:1 to 20:80, preferably from 97:3 to 50:50, for example 97:3 to 70:30 or 97:3 to 75:25. This ratio helps to provide the three-dimensional network with structural strength and insolubility whilst retaining good dye-capture and dye-retention properties. However, it can be more helpful to define the relative amounts of the two polymers by their respective average molecular amounts of reactive functional groups, i.e. (N—H) reactive functional groups for the first polymer, and halohydrin and/or epoxide reactive functional groups for the second polymer. It can be advantageous that the first and second polymers are present in relative amounts such that the relative molecular ratio of the halohydrin and/or epoxide functions to the (N-H) functions in the range of from 0.0035 to 0.0380. Without wishing to be bound by theory, it is believed that this ratio is preferential because the resulting three-dimensional network will have high strength, very low water-solubility and a high degree of dye retention.

In another embodiment, the molecular ratio of the halohydrin and/or epoxide functional groups in the second polymer to the (N—H) functional groups in the first polymer is in the range of 0.0035 to 1.0000 when the second polymer also contains quaternary ammonium groups as described earlier, more preferably in the case where the second polymer also has groups according to the Formula (II). Without wishing to be bound by theory, it is believed that the range of ratios for this embodiment can be broader than the range of ratios in the previous paragraph because the second polymer in this embodiment contains quaternary ammonium groups that can contribute to retaining dye compounds.

The three-dimensional network can have a basis weight of from 0.5 to 30.0 g/m², more preferably from 1.0 to 20.0 g/m², for example 1 to 15 g/m², in particular 1 to 10 g/m². For the avoidance of doubt, these ranges refer to the total dry mass of the first and second polymers and are based upon the area of one side of the sheet. Whilst traditional laundry aid treatments have typically been applied heavily on a substrate, as explained above in relation to US2003/0118730, this is not necessary with the three-dimensional network used in the present invention because it very efficiently captures dyes even when present in relatively small amounts. This represents a significant cost-saving to the would-be manufacturer since less raw materials are required.

The present technology also reduces the need for the cross-linking component. In an embodiment, the content of the second polymer is 1 to 20 weight-% calculated from the dry mass of the three-dimensional network.

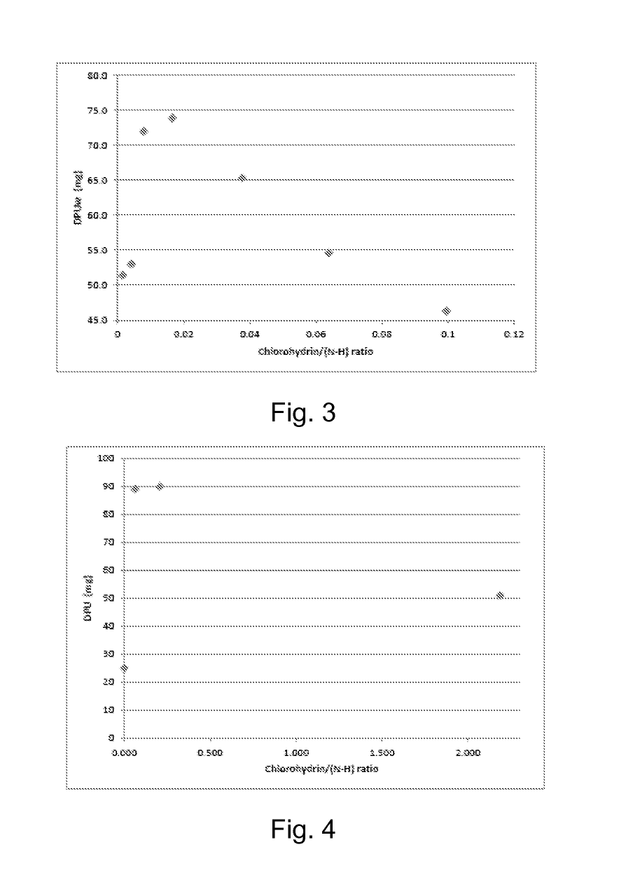

As mentioned above, the laundry aid contains an entangled mixture of support fibers, first polymer chains and second polymer chains, wherein the second polymer chains cross-link the first polymer chains. A small section of the entangled mixture is shown schematically in FIG. 3C, wherein a support fiber 3 is shown as being entangled with the three-dimensional network comprising the first polymer 1 cross-linked by the second polymer 2 by virtue of the amine groups 1a. Needless to say, FIG. 3C does not show the full extent of the entanglement because, to avoid undue complexity, it depicts only a small region around a portion of just a single support fiber. In reality, the support fibers and the chains of the first polymer will extend a distance though the material, and would therefore intertwine with neighboring support fibers and first polymer chains to form a matrix of different fibers and polymer chains. The cross-links formed by the second polymer serve to glue the support fibers and first polymers together in the entangled matrix of fibers and polymer chains.

The entangled mixture comprising fibers of the support and the three-dimensional network of first and second polymers is such that, without the cross-links, the fibers, first polymer chains and second polymer chains would resemble a web of individual support fibers and polymer chains of the first and second polymers. When viewed on a microscopic scale, the non-cross-linked mixture of support fibers and polymer chains would appear as an intricate matrix of strands not unlike cooked spaghetti. However, the cross-links present within the three-dimensional network drastically alter the properties of the entangled mixture because the cross-links restrict the movement of the first and second chains in the matrix, relative to the support fibers. This restriction of movement is thought to occur because the entwined mixture of support fibers, first polymer chains and second polymer chains are knitted together by the cross-links, such that the three-dimensional network becomes anchored around the numerous fibers of the support.

As will be understood from the above description, the cross-links in the three-dimensional network do not need to prevent all movement of the support fibers, first polymer chains and second polymer chains. For example, there will generally be a degree of freedom of movement on a relatively local scale, i.e. short range movement, since the various strands of polymeric chains/support fibers will be able to ‘wriggle’ and bend etc. with the entangled matrix. However, the cross-links suppress long-range movement of the various components within the entangled mixture of support fibers and polymer chains because the polymer chains and the support fibers are knitted together in the matrix. Accordingly, the polymer chains and support fibers are incapable of completely escaping the laundry aid because the first polymer chains surrounding the support fibers are stitched/glued together by the cross-links provided by the second polymer. In essence, the cross-links secure the entanglement.

The restriction of long range movement in the entangled mass is particularly useful with respect to the first polymer because the positively-charged first polymer, which is capable of binding to dye molecules, is firmly anchored with the entangled mixture of the laundry aid. Therefore, dyes that are captured by the first polymer during use will also be firmly anchored by the laundry aid. Needless to say, this effect also applies to other components of the entangled mass that are able to capturing dyes, such as the second polymer, because these other components are similarly anchored by entanglement and cross-linking. An important advantage of the cross-linking reaction reported in the present invention is the fact that the formed cross-links are not hydrolysable even under severe conditions.

The relative arrangement of fibers, first polymer chains and second polymer chains is not particularly limited. For example, the fibers of the support can be deliberately arranged, such as being woven in place or the support fibers can be distributed randomly (e.g. the support is a nonwoven web). In either case, the intertwining first polymer chains will surround the support fibers and will be held in place by the cross-links provided by the second polymer.

The entanglement/cross-linking can be described in various ways. For example, this can be expressed in terms of the insolubility of the first polymer in the laundry aid, which is based upon the concept that first polymer chains anchored within the three-dimensional network by cross-linking will not be able to dissolve when the laundry aid is immersed in water. Without wishing to be bound by theory, it is believed that chains of the first polymer can potentially escape the three-dimensional network by at least two mechanisms. On the one hand, first polymer chains that are not cross-linked by the second polymer will not be as securely anchored by network, and will therefore potentially be able to escape. On the other hand, it is possible, though highly unlikely, that cross-links will be hydrolyzed by immersion of the laundry aid in an aqueous medium, and so a first polymer chain that has been freed of all cross-links will also have the potential to escape the laundry aid. An important advantage of the cross-linking in the laundry aid is that the cross-links are not hydrolysable under even the most severe washing conditions that the laundry aid is likely to encounter during use. Accordingly, it is highly unlikely that the three-dimensional network will break down under the stresses of everyday, normal use.

For example, insolubility of the first polymer after cross-linking can be expressed in terms of the following titration test, but this should not be construed as an essential feature of the present invention. More specifically, the titration requires that a pH 6.5 aqueous composition that has been obtained by immersing 50 g of the laundry aid in one liter of water at 70° C. for 10 minutes requires ≦3 mmol of NaOH to raise the pH of the aqueous solution from 6.5 to 10.5 at 25° C. Preferably, the amount of NaOH required is ≦2.5 mmol, and more preferably ≦2 mmol. Further details on how this test can be conducted are provided in the Examples section below.

This test is, therefore, based upon the concept that amines that have escaped the laundry aid during immersion in water will be protonated at pH 6.5. Accordingly, the amount of NaOH required to increase the pH from 6.5 to 10.5 will indicate the extent to which amines have escaped the laundry aid during immersion of the laundry aid in water and therefore remain in the aqueous composition after the laundry aid has been removed. Of course, it will be appreciated that the titration test will also take into account other substances in the aqueous composition that undergo an acid-base reaction in the pH range of 6.5 to 10.5.

By way of example, the following combinations of first and second polymers are just some of the many ways in which to achieve the level of insolubility described above by the titration test:
The first polymer is a polyvinylamine having an average molecular weight in the range of 100,000 to 750,000, the second polymer is an epichlorohydrin- modified polyamide having an average molecular weight in the range of from 5,000 to 100,000, the mass ratio of the first and second polymers is in the range of from 97:3 to 75:25, and optionally wherein the ratio of chlorohydrins groups to the N—H groups between the second and first polymers is in the range of from 0.0035 to 0.0380.
The first polymer is a polyethyleneimine having an average molecular weight in the range of 100,000 and 1,000,000, the second polymer is a polymer having both quaternary ammonium groups and epichlorohydrin groups and has an average molecular weight in the range of from 5,000 to 200,000, the mass ratio of the first and second polymers is in the range of from 97:3 to 50:50, and optionally wherein the ratio of chlorohydrin groups to the N—H groups between the second and first polymers is in the range of from 0.0035 to 1.0000.
The first polymer is a polyallylamine comprising quaternary ammonium groups and has an average molecular weight in the range of 100,000 and 1,000,000, the second polymer is a polymer having both quaternary ammonium groups and epichlorohydrin groups and has an average molecular weight in the range of from 5,000 to 200,000, the mass ratio of the first and second polymers is in the range of from 97:3 to 50:50, and optionally wherein the ratio of chlorohydrin groups to the N—H groups between the second and first polymers is in the range of from 0.0035 to 0.0380.

An alternative and/or additional way of expressing the insolubility of the first polymer in the laundry aid is the UV-Vis absorbance spectrum method described in the Examples, wherein the extent to which the first polymer can escape the laundry aid is assessed by detecting complexes formed between the first polymer and a dye compound. In addition, the laundry aid can take the form of a porous envelope/sachet surrounding an inner chamber. This arrangement can, for example, be obtained by preparing a porous sheet-like laundry aid and heat bonding the perimeter of the sheet to another substrate. For example, heat-bonding the perimeter of such a sheet-like laundry aid to another a porous sheet of the laundry aid would result in complete article resembling a tea-bag, though not necessarily of similar size. Hence the envelope/sachet is porous to water without being soluble in water. The latter type of article has the benefit of being able to accommodate useful materials within the chamber formed by the laundry aid, such as detergents, softeners and so forth. Buoyancy aids can also be housed in the inner chamber so that the laundry aid has a tendency to float in the wash liquor.

### Process of Producing Laundry Aid

The process by which the laundry aid is produced is not particularly limited, which is a further benefit of the present invention. However, one useful method of producing the laundry aid includes the steps of:
(i) sequentially or simultaneously impregnating the fiber-containing support with the first polymer and the second polymer; and
(ii) cross-linking the first polymer with the second polymer in the support to form the three-dimensional network of cross-linked first and second polymers.

The method by which the fiber-containing support is impregnated with the first and second polymers is not particularly limited. For example, the fiber-containing support can be soaked in a solution, such as an aqueous solution, of each polymer separately or a solution containing both polymers together. However, it can be preferable to impregnate the support with a solution containing both the first and second polymers, as this will help to maximize mixing between the two polymers, and therefore enhance entanglement and cross-linking.

Impregnation can also be achieved by a so-called padding technique, wherein the fiber-containing support is contacted with a solution of the first and second polymers (or separate solutions of the first and second polymer, either sequentially or simultaneously) before being passed through nip rollers. The squeezing action of the rollers helps to force the solution of first and/or second polymers deep into the fiber-containing support, such that the resulting cross-linking causes a high level of entanglement with the fibers of the support. Since the squeezing action of the rollers causes deep impregnation of the first/second polymers, then the method by which the solution of the first and/or second polymers is initially contacted with the fiber-containing support is not particularly limited.

Non-limiting examples of this the contacting step include spraying the support with the polymer-containing solution(s) or immersing the support in the polymer-containing solution(s).

Various other components can be added prior to or simultaneously with the first and/or second polymers. For example, when using a particularly hydrophobic support, such as a polyalkene support, it can be helpful to use a wetting agent in order to aid penetration of the hydrophilic first and second polymers deep into the support. This can also be useful if the first and/or second polymers are applied in the form of an aqueous solution.

Cross-linking can be conducted by any appropriate means. In many cases, due to the close proximity of the reagents and the types of reacting functional groups involved, cross-linking occurs spontaneously by ageing. If desirable, it can be helpful to promote cross-linking by heating/curing the impregnated support so as to thermally promote cross-linking. Any other conventional way of increasing the rate of reaction can also be used to promote cross-linking, such as photochemical rate acceleration.

In addition, cross-linking can be promoted by creating an alkaline environment in the laundry aid. For example, this can be achieved by impregnating the support with an alkaline solution of the first and/or second polymers. An alkaline environment can assist cross-linking by a number of ways. On the one hand, and alkaline environment helps to make the amine groups of the first polymer more nucleophilic, and therefore more reactive towards the cross-linking groups of the second polymer. On other hand, the alkaline environment can help to absorb acidic byproducts of the cross-linking reaction that might otherwise retard further cross-linking. For example, the putative byproduct formed by reacting an amine with a halohydrin group is HCI, but this would be consumed by an alkaline environment. Any alkalinity remaining after the cross-linking reaction can be removed by, for example, washing with water, but this is not strictly necessary since the laundry aid will be washed in situ during use, thereby providing the necessary cationic environment for use.

The sequence of events described above is illustrated in FIG. 3, wherein FIG. 3A depicts a solution containing first polymer 1 and second polymer 2, FIG. 3B depicts the support impregnated with the first and second polymers prior to cross-linking, and FIG. 3C depicts the cross-linked three-dimensional network entangled with the support. As mentioned above, FIG. 3 depicts only a small portion of the entangled mixture of support fibers and three-dimensional network in order to avoid undue complexity. As can be understood from FIG. 3B, impregnating the support with the first and second polymers caused them to pass between and surround fibers within the support. Then, once cross-linking occurs between the second polymer 2 and the amine groups 1a of the first polymer 1, the first fibers are locked in place between and around the support fibers.

It can also be helpful to dry the impregnated support, since this will help to remove water that might remain from the impregnation step. The drying step can be conducted by exposing the impregnated support to elevated temperatures for a period of time, wherein shorter drying times are generally associated with higher temperatures. As a guide, drying can be conducted by exposing the impregnated support to temperatures of 50-150° C. for 0.5-30 minutes. Drying can also be promoted by exposing the impregnated support to a vacuum during drying, wherein drying in a vacuum generally requires lower drying temperatures than when drying at ambient pressure. Of course, the drying step will itself also help to promote cross-linking. Moreover, the drying step can be conducted before, during or after the cross-linking step.

The sheet-form laundry aid can also be formed into more complex structures, such as a water-porous sachet or pouch such that additives house within the sachet or pouch can also play a part in the laundering process. Additives suitably housed within the sachet or pouch include those listed above as potential additives of the laundry aid in general.

The way in which the sheet-like laundry aid can be converted into the sachet/pouch is not particularly limited. For instance, the sheet-like laundry aid can be folded in two and secured along their periphery of the sides with suitable additives enclosed therein the so-formed pouch or sachet. Alternatively, the wall of the bag or sachet may consist of two sheets of the laundry aid secured together about their periphery with the additive enclosed therein. An optional variant of the second approach is to attach one sheet of the laundry aid to another type of sheet altogether by sealing the periphery of the laundry aid to the other material, provided of course that it is suitable for use in a laundering operation. The method by which the various seals/joins can be made to form the sachet or pouch is not particularly limited, but such a seal/join can be made using thread and/or the heat-sealable component mentioned above.

### Use of Laundry Aid

As mentioned above, the laundry aid of the present invention is able to capture dyes from an aqueous medium, which is thought to occur by the laundry aid intercepting the dyes as they move around the aqueous medium. In essence, it is believed that dye molecules, particularly acid dye molecules, coming into close proximity with the laundry aid will experience an intermolecular attraction with appropriate chemical groups of the laundry aid, wherein the appropriate groups of the laundry aid will typically include the cationic groups of the first and, optionally, second polymers. As mentioned above, the cationic groups can possess a permanent cationic charge, such as a quaternary ammonium group, or may have a cationic charge when operating under typical laundry conditions, such as an amine group. Once this intermolecular attraction has taken effect, the dye molecule will be held in place by the laundry aid because the appropriate groups of the first/second polymers are anchored to the laundry aid by virtue of the cross-linked entanglement described above.

The laundry aid of the present invention is particularly well-suited to capturing direct dyes, which are sometimes termed substantive dyes. These types of dyes do not react with the material to be colored (unlike reactive dyes, for instance) and do not use a mordant, but instead rely upon intermolecular forces in order to adhere to the dyed material. For example, direct dyes are frequently used when dying household fabrics such as cotton.

However, the lack of a chemical bond can mean that direct dyes tend to dissociate from the dyed fabric, and so these types of dyes are frequently associated with unwanted color runs during laundering. Moreover, direct dyes tend to have anionic character in the form of a negative charge (such as a sulfonate group) or polarized groups that have anionic character, such as the carbonyl function within an amide group. These types of direct dyes are particularly susceptible to capture by the laundry aid of the present invention since the cationic groups are able to form electrostatic interactions and/or hydrogen bonds with the anionic or anionic-type groups of direct dyes.

The laundry aid can be used to capture dyes during the laundering of fabrics, textiles, clothing and so forth by simply placing the laundry aid in the washing apparatus along with the items to be laundered prior to commencing laundering. The laundry aid will then capture dyes liberated by the aqueous wash medium during the laundering cycle and therefore reduce the likelihood of unwanted ‘color runs’. Visual inspection of the laundry aid after use will tend to reveal whether dyes have been captured because the laundry aid will discolor. It is therefore helpful if the laundry aid has a pale color, preferably white, because this will enable facile visual detection of dye capture and therefore reassure the user that the laundry aid is functioning properly.

### EXAMPLES

The present invention will now be illustrated by way of experimental Examples, but these should not be understood as limiting the scope of the present invention.

Preparation of handsheets used in the Examples:—Pulp fiber (50 dry grams) was soaked in 2.7 liters of water at 50° C. for 20 min. The pulp was then disintegrated using a Messmer MK III C disintegrator for 30,000 rotations at 3,000 rpm. The resulting slurry was diluted with water to a pulp concentration of 1.0 g/liter. Under slight mechanical agitation, the desired amount of synthetic fibers (viscose, and/or polyester for example) was added to the pulp slurry. A wet strength agent (e.g. Giluton 1100-28N, available from BK Giulini) was added to the slurry at 0.40% dry weight of the total dry pulp. A volume of the slurry was then poured into a Rapide Köthen Sheet Machine Automatic, 200 mm diameter [available from Frank PTI, Germany] to achieve the target base weight. After pouring the slurry into the mold, the slurry was agitated with compressed air and then drained through a 90×90 mesh stainless steel wire with vacuum assistance. The sheet was then removed from the wire mesh by pressing against dry blotter paper before being further compressed by passing a 2 kg roller over the sheet 10 times. The handsheet was then removed from the blotter paper and dried on a drying cylinder at 135° C. for 5 minutes.

### Test Methods

Dry Tensile Strength:—Measurements were taken according to TAPPI Standard T494 om-96 with the following modifications: 50 mm strips were used, the initial jaw distance was 127 mm, the break force value was recorded as the maximum of the recorded force curve. Elongation value was recorded at 75% of maximum force. Tensile strength is expressed as an arithmetic average of machine direction and cross direction. All testing was conducted under laboratory conditions of 23.0±1.0° C. and 50.0±2.0% relative humidity after samples had equilibrated under these conditions for at least 24 hrs.

Wet Tensile Strength:—Measurements were taken according to the same test method as for the Dry Tensile Properties described above, except that sample strips were first immersed in a water bath at a depth of 20 mm for 10 min, followed by removing excess water by placing the immersed sheet between two absorbent papers (e.g. blotter paper reference 0903F available from Fioroni) with no pressure applied. Wet/dry ratio is defined as the average wet tensile strength divided by the average dry tensile strength.

Dye Pick-Up (DPU):—A 250×125 mm (312.5 cm²) sheet was placed in one liter of a vigorously agitated aqueous dye solution heated to 70° C., wherein the dye solution comprised Direct Red Dye (Indosol Red BA P 150 from Clariant) at a concentration of 200 mg/liter. The sample was then removed after 3 minutes and a 10 mL aliquot was taken from the dye solution and diluted to a total volume of 200 mL in readiness for measurement. The absorbance of the diluted aliquot was measured at the maximum absorbency wavelength of Indosol Red BA P 150 (526 nm) using a calibrated Perkin Elmer Lambda 20 spectrophotometer.

Using a standard calibration curve correlating the absorbance at 526 nm to the concentration of dye in solution (Beer-Lambert Law c=A/[ε×I]; where c=dye concentration, A=absorbance, ε=molar absorption coefficient, and I=optical path length), the absorbance obtained experimentally was converted into the dye concentration in solution (mg/L). The Dye pick-up (DPU) value is the difference between the concentration of dye measured before and after the immersion of the sample sheet in the solution. The DPU is considered as the amount of dye removed from the solution and adsorbed by the sample sheet and is expressed in mg of dye per sample sheet (area of 312.5 cm² for all samples tested). The DPU values are reported as the average value obtained by the testing of three separate sheets. DPU of samples that have not been subjected to the Washing Protocol (see below) are noted as DPU₀ and samples that have been subjected to the Washing Protocol are noted as DPU_{w} sample, the samples underwent the following washing protocol. The sample (250×125 mm) was placed in 1 liter of water at 70° C. The sample was maintained in the bath under vigorous stirring for 10 minutes, before being removed, hung up for 10 minutes to drain and dried on hot plate for 5 minutes at 95° C.

### Insolubility

The extent to which the three-dimensional network has rendered its components insoluble in water can be assessed by the following two methods.

First method:—quantifies the percentage of soluble and insoluble polyamine by titration of the waste water obtained by washing the sample sheet, and is based on the concept that the pH of an aqueous medium influences whether polyamines are protonated or not. In particular, titration of a neutral/acidic solution of polyamine with strong base enables the amount of strong base used for the titration to be correlated with the amount of polyamine present in solution. A dedicated calibration curve is therefore required for each polyamine tested since each polyamine has a characteristic titration curve. The first method therefore involves three phases: preparation of the calibration curve; washing of samples; and titration of the wash solution.

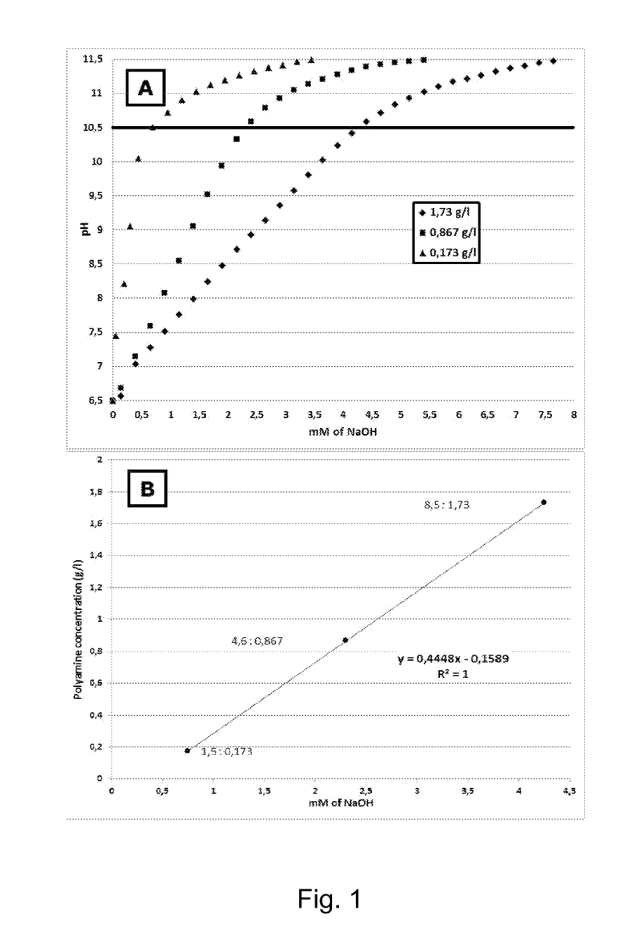

Preparation of the calibration curve: One liter aqueous solutions containing the polyamine at various concentrations are prepared by dissolving or diluting the polyamine in water and the pH of each solution is adjusted to pH 6.5 by addition of NaOH (0.5M) or HCI (0.5M). Each solution is then titrated by the addition of NaOH (0.5M) solution, the amount of NaOH required to reach pH 10.5 is quantified and the quantity is converted into mmol of NaOH. As an illustrative example, the titration curves obtained for a polyvinylamine having an average molecular weight of 340,000 (wherein <10% of the amine groups are capped with formyl groups) is shown in FIG. 1A. The values (mmol of NaOH for titration from pH 6.5 to pH 10.5 and concentration of polyamine) are reported as a graph and the calibration curve is then obtained by simple linear regression evaluation, using the least square method. A calibration curve for the polyamine of FIG. 1A is reported as an example in FIG. 1B.

Washing of samples:—50 g of sample is cut into pieces and placed together in one liter of water at 70° C. under magnetic stirring for 10 minutes. After 10 minutes, the samples are removed. The wet samples are then put in a Buchner funnel and washed under vacuum filtration with 20 mL of demineralized water. After vacuum-washing of the sample, the solution collected in the vacuum flask is added to the wash solution. The volume of the wash solution is re-adjusted to the initial volume of one liter by addition of demineralized water or by evaporation (keeping the solution under constant stirring at 70° C.).

Titration: The wash solution is cooled to 25° C., maintaining continuous magnetic stirring, and a pH-meter is placed in contact with the solution. The pH is adjusted to 6.5 by addition of NaOH (0.5 M) or HCI (0.5 M) if necessary. A 0.5 M NaOH solution is then added dropwise to the wash solution from a volumetric burette and the volume of 0.5 M NaOH required to reach pH 10.5 in the wash solution is recorded and then converted into mmol of NaOH.

Using the appropriate calibration curve, the quantity of NaOH is converted to grams of solubilized polyamine per liter (g/L). This enables the percentage of the soluble and insoluble polyamine of the sample to be determined, provided that the initial amount of polyamine applied on the sample is known.

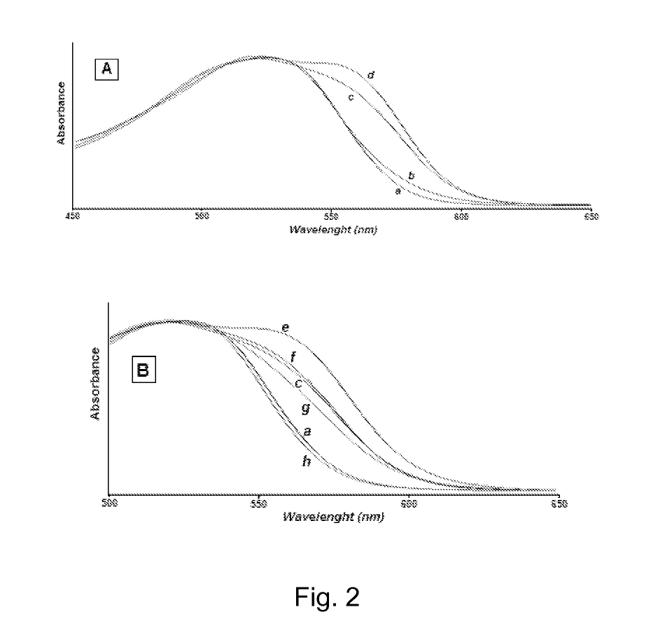

Second method:—evaluates the UV-Vis absorbance spectra of dyes in solution with polyamines during the Dye Pick-Up (DPUO) test. In essence, the second method is based upon the fact that polyamines interact with acid dyes in solution to form complexes, which absorb at different wavelengths compared to a pure dye solution. Evaluating the UV-Vis spectrum therefore enables the user to observe the formation of a second absorbance peak that indicates the formation of a complex (comparison between spectra a and d in FIG. 2A).

When performing the DPU₀ test, if the spectrum indicates the appearance of another absorbing species, such as a dye-containing complex, by the emergence of a second absorbance peak(e.g. two peaks reported for d in FIG. 2A), then the solubility of the polyamine is considered to be too high for use in the laundry aid, and the DPU₀ value is considered as not relevant. If a more sensitive evaluation of the solubility is required, then the evaluation of the spectra using the washing test solution can be performed. In this case, the whole washing test solution is combined with 12.5 mg of Indosol Red BA P 150 dye at 25° C. under vigorous stirring. The absorbance spectrum is then acquired without further dilutions of the solution. By comparison of the absorbance spectra from standard solutions of polyamine (with 2.5 mg of Indosol Red BA P 150 dye) to the absorbance spectra of the washing test solution, it is possible to evaluate the percentage of the soluble polyamine of the sample (e.g. comparison in FIG. 3B between the spectrum c [equivalent to a theoretical loss of 2.5% by mass for a media containing 4 g/m² of the polyvinylamine] with the spectra e, f, g, h).

Heat Sealability test:—The heat sealability of a sample is evaluated according to the following procedure, which is a modification of ASTM F88-06: a 150 mm (machine direction, MD)×25 mm (cross machine direction, CD) sample is cut and folded perpendicular to the longer dimension such that two heat sealable sides are facing each other (in the case where the two sides of the sample are both heat sealable, the sample is folded arbitrary to one of the two sides). The folded sample is heat sealed with a Laboratory Heat Sealer (available from British Cellophane Research Service, Bridgewater, England). The folded edge is placed between the heated metallic 20 mm×55 mm jaw and against a non-heated soft rubber surface, with the long dimension perpendicular to the jaw. The sample is then heat-sealed along the entire 25 mm (along the cross machine direction CD of the sample) width and to a depth of 20 mm in the sample MD direction.

The sample is then heat-sealed between the jaws for a pre-determined length of time and at a predetermined pressure and temperature [see Table 8]. The two unsealed edges of the sample are placed in the jaws of an Instron Dynamometer (Model No. 1122 available from Instron, Mass. USA). The sample, with the heat-sealed seam in the center of the test strip, is then pulled in opposite directions at a constant rate of elongation of 300 mm/min.

The force is recorded as function of the elongation. Both average seal strength and maximum seal strength are measured and expressed in g per 25 mm.

### Example 1

### Ratio and Total Amount of the First and Second Polymers

Nonwoven handsheets (50 g/m²) comprising 67% cellulose (softwood Sodra Blue 90Z) and 33% viscose (Kelheim Danufil KS 1.7dtx×8 mm) were impregnated with a polyvinylamine having an average molecular weight of 340,000 (wherein <10% of the amine groups are capped with formyl groups) and an epichlorohydrin-modified polyamide polymer (Giluton 1100-28N from BK Giulini). The impregnation step was conducted by padding the sheet (using a Mathis size-press at 1.8 bar of pressure) with a solution of these polymers obtained by mixing the polymers, diluting with water and adjusting to pH 10 with NaOH (solution 30% w/w). The amount of these polymers in the resulting handsheets was varied by varying the concentration of the polymers in the padding solution. The handsheets were then dried on a hot plate at 110° C. for 2 minutes and then cured in a forced air oven at 135° C. for 5 minutes.

The resulting DPU values before (DPU₀) and after washing test (DPU_{w}) are reported in Table 1. In addition, the solubility results are shown for each sample, wherein a value of <1% is considered to be practically insoluble based upon the detection limits of the method.

Moreover, the titration results show that a value of less than 3 mmol NaOH corresponds to a very low solubility of the polyamine.

FIG. 3 reports the DPU values after the washing test (DPU_{w}) as a function of the ratio epichlorohydrin to (N—H) functional groups, wherein a preferable range for this ratio of functional groups is shown in terms of effective DPU values and low solubility.

TABLE 1

| | Amount of | | Amount of | Chloro- | First | | | | Solubility | |
|---|---|---|---|---|---|---|---|---|---|---|
| | First | (N—H) | Second | hydrin | Polymer/ | Chloro- | | | of First | NaOH for |
| | polymer | group | Polymer | group | Second | hydrin/ | DPU₀ | DPU_{w} | Polymer | titration |
| Sample | (g/m²) | (mmol) | (g/m²) | (mmol) | Polymer | (N—H) | (mg) | (mg) | (%)** | (mmol)*** |
| 1 | 4 | 88.4 | 0.04 | 0.13 | 99/1 | 0.001 | 42* | 51 | 10 | 3.11 |
| 2 | 4 | 88.4 | 0.11 | 0.39 | 97.3/2.7 | 0.004 | 50 | 53 | 4 | 2.23 |
| 3 | 4 | 88.4 | 0.21 | 0.69 | 95/5 | 0.008 | 72 | 72 | 2 | 1.49 |
| 4 | 4 | 88.4 | 0.44 | 1.45 | 90/10 | 0.017 | 77 | 74 | ≦1% | 0.68 |
| 5 | 4 | 88.4 | 1.00 | 3.30 | 80/20 | 0.038 | 71 | 65 | ≦1% | 0.45 |
| 6 | 4 | 88.4 | 1.71 | 5.61 | 70/30 | 0.063 | 59 | 55 | ≦1% | ≦0.45 |
| 7 | 4 | 88.4 | 2.67 | 8.91 | 60/40 | 0.101 | 44 | 46 | ≦1% | ≦0.45 |
| 8 | 5.4 | 118.1 | 0.59 | 1.98 | 90/10 | 0.017 | 81 | 79 | ≦1% | 0.60 |
| 9 | 7.2 | 157.5 | 0.79 | 2.64 | 90/10 | 0.017 | 88 | 89 | ≦1% | 0.85 |

*no shift observed in the UV spectrum of the washing solution;
**determined by the UV-VIS method.
***Titration method

### Example 2

### Cationic Second Polymer

Nonwoven handsheets (50 g/m²) comprising 67% cellulose (softwood Sodra Blue 90Z) and 33% viscose (Kelheim Danufil KS 1.7dtx×8 mm) were impregnated with a polyethyleneimine having an average molecular weight 750,000 a.m.u. (Polymin® P from BASF) and a polymer obtained from epichlorohydrin and diallyl dimethyl ammonium chloride poly[2-propen-1-aminium,N,N-dimethyl-N-2-propenyl-chloride]-co-[1-chloro-3-(di-2-propenylamino)-2-propanol hydrochloride] having an average molecular weight of 40,000 a.m.u (PAS-880 from Nittobo, Japan). The impregnation step was conducted by padding (using a Mathis size-press at 1.8 bar of pressure) the handsheets with a solution obtained by mixing the polyethyleneimine and epichlorohydrin-modified polyamine, diluting with (deionized) water and adjusting the pH of the solution to pH 10 using NaOH (solution 30% w/w). The impregnated handsheets were dried on a hot plate at 110° C. for 2 minutes and subsequently cured in a forced air oven at 135° C. for 5 minutes.

The resulting DPU values before (DPU₀) and after the washing protocol (DPU_{w}) are reported in Table 2. As shown in Table 2, using only one polymer for impregnation (samples 10 and 14) results in very low DPU_{w} values after the washing protocol. Such distortion in DPU₀ value and low DPU_{w} values can be attributed to the loss of polymer (active sites for catching dye) into the water solution during the DPU test and/or during the washing protocol (i.e. no formation of the three-dimensional network within the nonwoven sheet).

FIG. 4 shows the DPU_{w} value (after the washing protocol) as function of the ratio Epichlorohydrin/(N—H) functional groups. Sample 10 is not shown because of the infinite ratio value. FIG. 2 shows a preferable range of this ratio for which a high value of DPU is obtained and where the treatment can be considered non-soluble (UV-VIS test method). The preferred ratio range is quite broad, which can be attributed to the presence of the cationic cross-linker (second polymer) since this polymer can simultaneously function as both a cross-linker of the first polymer and as dye-sequestering agent.

TABLE 2

| | Amount of | | Amount of | Chloro- | First | | | |
|---|---|---|---|---|---|---|---|---|
| | First | (N—H) | Second | hydrin | Polymer/ | Chloro- | | |
| | Polymer | group | polymer | group | Second | hydrin/ | DPU₀ | DPU_{w} |
| Sample | (g/m²) | (mmol) | (g/m²) | (mmol) | Polymer | (N—H) | (mg) | (mg) |
| 10 | 0 | 0 | 4.0 | 11.3 | 0/100 | infinite | n.a.*^{a} | 15* |
| 11 | 0.2 | 4.91 | 3.8 | 10.7 | 5/95 | 2.186 | 60 | 51 |
| 12 | 2.0 | 49.1 | 3.6 | 10.2 | 35/65 | 0.207 | 94 | 90 |
| 13 | 3.6 | 88.4 | 2.0 | 5.7 | 65/35 | 0.064 | 90 | 89 |
| 14 | 4.0 | 98.2 | 0 | 0 | 100/0 | 0 | n.a.* | 25* |

*Shift observed in the Vis-UV spectrum in the washing solution after dye addition.
^{a}Measurement not relevant due to the absorbance spectrum being significantly distorted/shifted by the formation of precipitates of polymer-dye complexes in the DPU₀ solution.

### Example 3

### Cationic Second Polymer

Nonwoven handsheets (50 g/m²) comprising 67% cellulose (softwood Sodra Blue 90Z) and 33% viscose (Kelheim Danufil KS 1.7dtx×8 mm) were impregnated with a polyvinylamine having an average molecular weight of 340,000 (wherein <10% of the amine groups are capped with formyl groups) and a copolymer of epichlorohydrin and diallyl dimethyl ammonium chloride (poly[2-propen-1-aminium,N,N-dimethyl-N-2-propenyl-chloride]-co-[1-chloro-3-(di-2-propenylamino)-2-propanol hydrochloride] having an average molecular weight 40,000 a.m.u. (PAS-880 from Nittobo, Japan). The impregnation step was performed by padding the handsheets (using a Mathis size-press at 1.8 bar of pressure) with a solution obtained by mixing the first and second polymers in the ratio prescribed in Table 3, dilution with (deionized) water and adjusting the pH of the solution to pH 10 using NaOH (30% w/w solution). The handsheets were then dried on a hot plate at 110° C. for 2 minutes and subsequently cured in a forced air oven at 135° C. for 5 minutes.

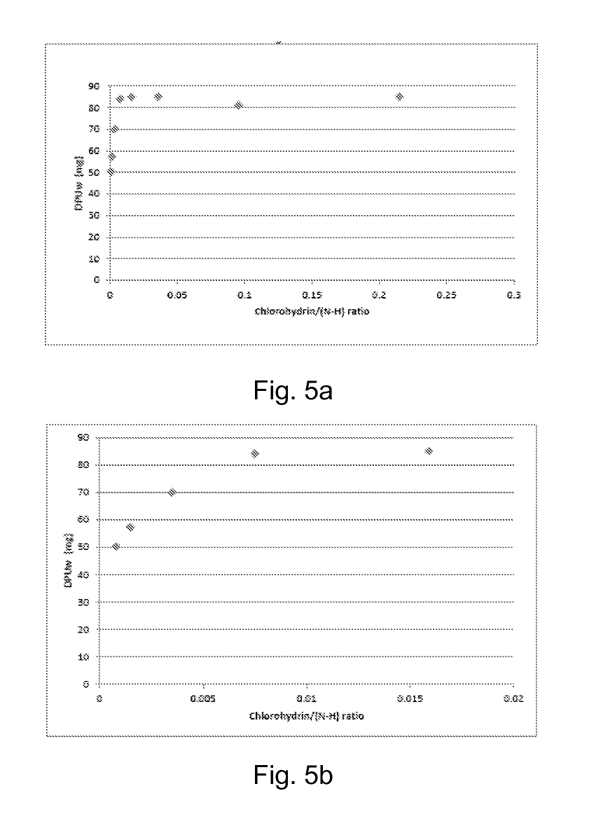

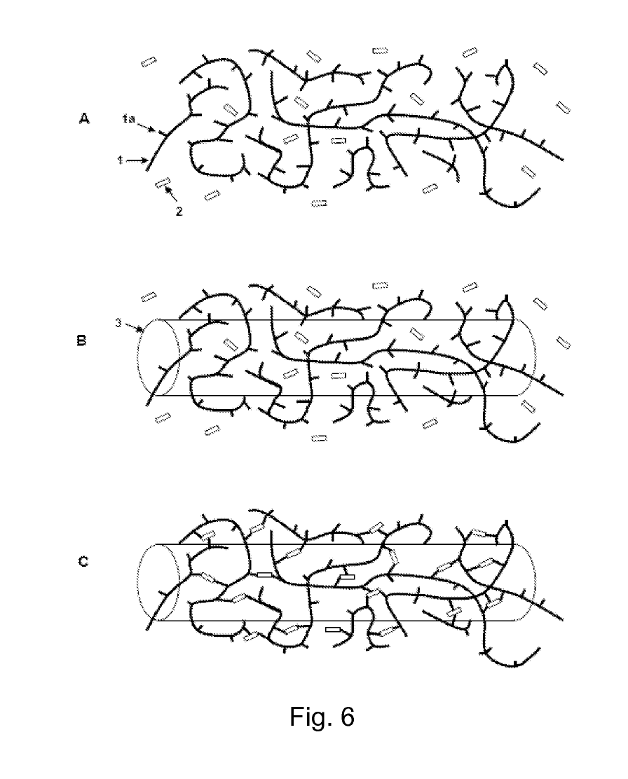

The resulting DPU values before (DPU₀) and after washing test (DPU_{w}) are reported in Table 3. The DPU values after washing are plotted in FIGS. 5a and 5b as a function of the ratio Epichlorohydrin/(N—H) functions. Sample 25 is not shown because of the infinite value of the ratio. As with Examples 1 and 2, the chlorohydrin:N—H ratio is shown to influence DPU value, wherein a ratio of 0.0035 and above is shown to be beneficial. As with Example 2, higher ratios do not limit DPU performance since the second polymer also contains cationic groups that are believed to assist DPU.

TABLE 3

| | Amount of | | Amount of | Chloro- | First | | | |
|---|---|---|---|---|---|---|---|---|
| | First | (N—H) | Second | hydrin | Polymer/ | Chloro- | | |
| | Polymer | group | Polymer | group | Second | hydrin/ | DPU₀ | DPU_{w} |
| Sample | (g/m²) | (mmol) | (g/m²) | (mmol) | Polymer | (N—H) | (mg) | (mg) |
| 15 | 7 | 139.5 | 0 | 0 | 100/0 | 0 | n.a.* | n.a.* |
| 16 | 6.96 | 138.7 | 0.04 | 0.11 | 99.5/0.5 | 0.0008 | 58* | 50 |
| 17 | 6.93 | 138.1 | 0.07 | 0.2 | 99/1 | 0.0015 | 54* | 57 |
| 18 | 6.83 | 136.1 | 0.17 | 0.48 | 97.5/2.5 | 0.0035 | 68* | 70 |
| 19 | 6.65 | 132.5 | 0.35 | 1.0 | 95/5 | 0.0075 | 88 | 84 |
| 20 | 6.3 | 125.5 | 0.7 | 2.0 | 90/10 | 0.0159 | 87 | 85 |
| 21 | 5.6 | 111.6 | 1.4 | 4.0 | 80/20 | 0.0358 | 89 | 85 |
| 22 | 4.2 | 83.7 | 2.8 | 8.0 | 60/40 | 0.0956 | 88 | 81 |
| 23 | 2.8 | 55.8 | 4.2 | 12.0 | 40/60 | 0.2150 | 86 | 85 |
| 24 | 1.4 | 27.9 | 5.6 | 16.0 | 20/80 | 0.5734 | 85 | 83 |
| 25 | 0 | 0 | 6.0 | 17.1 | 0/100 | Infinite | n.a.* | 30 |

*Measurement not relevant due to the absorbance spectrum being significantly distorted/shifted by the formation of precipitates of polymer-dye complexes in the DPU₀ solution.

### Example 4

### GMAC-Grafted first Polymer

### Preparation of a GMAC-Grafted First Polymer

30.4 g of polyallylamine (PAA—HCL-10L from Nittobo, Japan: aqueous solution at 40% w/w) was diluted in 50 ml of (deionized) water. Under vigorous stirring, 4.6 g of Glycidyl triMethylAmmonium Chloride (GMAC) (70% w/w aqueous solution, from Sachem, USA) was slowly added, and then the pH of the solution was adjusted to pH 10 by addition of NaOH (30% w/w aqueous solution). After 3 hours of constant stirring at 40° C., the solution was cooled to room temperature in readiness for analysis.

Analysis using a Thermo Finnigan Advantage Max Ion Trap Spectrometer equipped with an electrospray ion source (ESI) in positive ion acquiring mode indicated that the reaction was complete since the two main characteristic peaks for unreacted GMAC (m/z 116 and 267) were not observed. ¹H-NMR analysis (Bruker Avance 200 spectrometer at 200 MHz in D₂O, after reaction solvent evaporation) showed four new signals attributed respectively to NHCH₂, CHOH, CH₂N⁺ and N(CH₃)₃, corresponding to side chains attached to the polymer backbone. Moreover, integration of ¹H-NMR indicated that 12% of the NH₂ groups of the polyallylamine had been substituted with GMAC (integration of the 3×Me in the ammonium salt functionality of GMAC-derived side-chain compared with the integration of the CH₂ and CH in the polyamine backbone).

### Use of the GMAC-Grafted First Polymer

Handsheets (50 g/m²) comprising 67% cellulose (softwood Sodra Blue 90Z) and 33% viscose (Kelheim Danufil KS 1.7dtx×8 mm) were impregnated with solutions prepared by mixing the grafted polyamine obtained above with an epichlorohydrin-modified polyamide polymer (Giluton 1100-28 N) at the ratios indicated in Table 4, wherein the impregnation solutions were adjusted to pH 10 with NaOH (30% w/w solution). The impregnation step was conducted using a padding technique (Mathis size-press at 1.8 bar of pressure). The handsheets were then dried on a hot plate at 110° C. for 2 minutes and subsequently cured in oven at 135° C. for 5 minutes.

The resulting DPU values before (DPU₀) and after washing test (DPU_{w}) are reported in Table 4. As is deducible by the DPU values reported in Table 4, treatment with the grafted polyallylamine without a cross-linker does not render the first polymer insoluble. However, small amounts of the epichlorohydrin-modified polymer results in very low solubility.

TABLE 4

| | Amount of | | Amount of | Chloro- | First | | | |
|---|---|---|---|---|---|---|---|---|
| | First | (N—H) | Second | hydrin | Polymer/ | Chloro- | | |
| | polymer | group | Polymer | group | Second | hydrin/ | DPU₀ | DPU_{w} |
| Sample | (g/m²) | (mmol) | (g/m²) | (mmol) | Polymer | (N—H) | (mg) | (mg) |
| 26 | 6.0 | 143.6 | 0.0 | 0 | 100/0 | 0 | n.a.* | 26 |
| 27 | 5.4 | 129.3 | 0.6 | 1.98 | 90/10 | 0.0153 | 88 | 89 |
| 28 | 4.8 | 114.9 | 1.2 | 3.96 | 80/20 | 0.0344 | 75 | 73 |

*Measurement not relevant due to the absorbance spectrum being significantly distorted/shifted by the formation of precipitates of polymer-dye complexes in the DPU₀ solution

### Example 5

### CHTP-Grafted First Polymer

### Preparation of a CHTP-Grafted First Polymer

30.7 g of polyallylamine (PAA—HCL-10 L from Nittobo, Japan, 40% w/w aqueous solution) was diluted in 50 ml of water. Under vigorous stirring, 6 g of 3-Chloro-2-hydroxypropyl trimethylammonium chloride (CHTP) (69% w/w aqueous solution, from Sachem, USA) was slowly added, and the pH of the solution was adjusted to pH 10 by addition of NaOH (30% w/w aqueous solution). The solution was kept under vigorous stirring at 40° C. for two hours, and then cooled to room temperature in readiness for analysis.

Analysis using a Thermo Finnigan Advantage Max Ion Trap Spectrometer equipped with an electrospray ion source (ESI) in positive ion acquiring mode indicated that the reaction was complete since the two main characteristic peaks for unreacted CHTP (m/z 152 and 339) were not observed. ¹H-NMR analysis (Bruker Avance 200 spectrometer at 200 MHz in D₂O, after reaction solvent evaporation) showed four new signals attributed to NHCH₂, CHOH, CH₂N⁺ and N(CH₃)₃, corresponding to side-chains attached to the polymer backbone. Moreover, integration of ¹H-NMR indicated that 13% of the NH₂ groups of the polyallylamine had been substituted with CHTP (integration of the 3×Me in the ammonium salt functionality of CHTP side-chains compared with the integration of the CH₂ and CH in the polyamine backbone).

### Use of the CHTP -Grafted First Polymer

The grafted polyallylamine, produced as described above, was mixed with an epichlorohydrin modified polyamide polymer (Giluton 1100-28 N), diluted with (deionized) water and the pH adjusted to pH 10 with NaOH (30% w/w aqueous solution). Handsheets (50 g/m²) comprising 67% cellulose (softwood Sodra Blue 90Z) and 33% viscose (Kelheim Danufil KS 1.7dtx×8 mm) were impregnated with the polymer solution by padding (Mathis size-press at 1.8 bar of pressure). The treated handsheets were dried on a hot plate at 110° C. for 2 minutes and subsequently cured in a forced air oven at 135° C. for 5 minutes.

The resulting DPU values before (DPU₀) and after the washing protocol (DPU_{w}) are reported in Table 5. Comparing the DPU values reported in the Table 5 to the DPU values in Table 4, the grafting by CHTP produces similar results and conclusions to those for the case of GMAC grafting in Example 4.

TABLE 4

| | Amount | | Amount of | Chloro- | First | | | |
|---|---|---|---|---|---|---|---|---|
| | of First | (N—H) | Second | hydrin | Polymer/ | Chloro- | | |
| | Polymer | group | Polymer | group | Second | hydrin/ | DPU₀ | DPU_{w} |
| Sample | (g/m²) | (mmol) | (g/m² | (mmol) | Polymer | (N—H) | (mg) | (mg) |
| 29 | 6.0 | 139.4 | 0.0 | 0 | 100/0 | 0 | n.a.* | 22 |
| 30 | 5.4 | 125.5 | 0.6 | 1.98 | 90/10 | 0.0158 | 85 | 83 |
| 31 | 4.8 | 111.6 | 1.2 | 3.96 | 80/20 | 0.0355 | 74 | 77 |

*Measurement not relevant due to the absorbance spectrum being significantly distorted/shifted by the formation of precipitates of polymer-dye complexes in the DPU₀ solution.

### Example 6

### Varying the Support

Various nonwoven handsheets (shown in Table 6) were impregnated with a solution containing a polyvinylamine having an average molecular weight of 340,000 (wherein <10% of the amine groups are capped with formyl groups) and an epichlorohydrin modified polyamide polymer (Giluton 1100-28 N). The polymer solution was prepared by mixing the polymers, diluting with (deionized) water and adjusting the pH to pH 10 by addition of NaOH (30% w/w aqueous solution). The mass ratio of the polymers was 95:5, such that the ratio of epichlorohydrin group to (N—H) group was 0.0079. Impregnation of the nonwoven sheet was conducted by a padding technique (Mathis size-press at 1.8 bar of pressure), wherein the total amount of the first and second polymers added is shown in Table 6. The treated handsheets were then dried on a hot plate at 110° C. for 2 minutes and subsequently cured in a forced air oven at 135 ° C. for 5 minutes.

Handsheets made from 67% of cellulose (softwood Alabama River) and, respectively, (as indicated in Table 6) 33% viscose Danufil (KS 1.7dtx×8 mm, Kelheim, Germany), 33% polyethylene terephthalate (PET) (1.7dtx×6 mm, Advansa, Germany), 33% PET (1.7dtx×12 mm, Advansa, Germany) and 33% (6.7dtx×12 mm, Barnet, Germany) were prepared at a basis weight of 50 g/m². The non-cellulosic substrates were commercially available samples of polypropylene (PP) spunbond (Grade 0050 70 g/m², Fiberweb, USA and reference WL25026 23 g/m² from Ahlstrom, USA), polylactic acid spunbond (reference CD50105M 55 g/m² from Ahlstrom, UK), and a polyester needlepunch (reference BRN094150C 150 g/m² from Ahlstrom, France). For the pure synthetic spunbond and needlepunch sheets, a wetting agent (FLUOWET, Clariant, Switzerland) was added to the impregnating solution at a concentration of 0.5% w/w in order to assist in wetting the hydrophobic surfaces.

As shown by the results present in Table 6, the present invention provides excellent results in terms of DPU for various supports.

TABLE 6

| | | Amount of First | | |
|---|---|---|---|---|
| | | and second | DPU₀ | DPU_{w} |
| Sample | Support composition | Polymers (g/m²) | (mg) | (mg) |
| 32 | 50 g/m² Alabama cellulose | 8.9 | 113 | 112 |
| | 67% + Viscose 33% | | | |
| 33 | 50 g/m² Alabama cellulose | 7.8 | 124 | 123 |
| | 67% + PET 1.7dtx 6 mm | | | |
| | 33% | | | |
| 34 | 50 g/m² Alabama cellulose | 8.6 | 111 | 117 |
| | 67% + PET 1.7dtx 12 mm | | | |
| | 33% | | | |
| 35 | 50 g/m² Alabama cellulose | 7.9 | 106 | 100 |
| | 67% + PET 6.7dtx 12 mm | | | |
| | 33% | | | |
| 36 | 70 g/m² PP spunbond | 9.0 | 125 | 120 |
| | (0050) | | | |
| 37 | 23 g/m2 PP spunbond | 3.5 | 77 | 78 |
| | (WL25026) | | | |
| 38 | 55 g/m² PLA spunbond | 6.0 | 79 | 84 |
| | (CD50105M) | | | |
| 39 | 150 g/m2 PET needlepunch | 9.2 | 144 | 139 |
| | (BRN094150C) | | | |

### Example 7

### Tensile Strength of Handsheets

Handsheets having a mass of 50 g/m² were prepared comprising 67% cellulose (softwood Sodra Blue 90Z) and 33% viscose (Kelheim Danufil KS 1.7dtx×8 mm). The handsheets were impregnated with a solution prepared by mixing polyvinylamine having an average molecular weight of 340,000 (wherein <10% of the amine groups are capped with formyl groups) and a copolymer of epichlorohydrin and diallyl dimethyl ammonium chloride (poly[2-propen-1-aminium,N,N-dimethyl-N-2-propenyl-chloride]-co-[1-chloro-3-(di-2- propenylamino)-2-propanol hydrochloride] having an average molecular weight 40,000 a.m.u (such PAS-880 from NITTOBO, Japan) and adjusting the pH of the solution to pH 10 using sodium hydroxide solution 30% w/w). Impregnation of the nonwoven sheet was conducted by a padding technique (Mathis size-press at 1.8 bar of pressure). The handsheets were then dried on a hot plate at 110° C. for 2 minutes and subsequently cured in oven at 135° C. for 5 minutes.

The tensile strength of the sheets so-obtained was measured and the results are reported in Table 7. In the case of the untreated control handsheet (sample 41), the low strength (dry and wet) was recorded and the handsheet was prone to damage during handling (particularly the wet sample). In contrast, handsheets according to the present invention exhibited good levels of dry and wet tensile strength, which would be sufficient to survive use in a typical washing machine. The data therefore demonstrates that the present invention has the unexpected benefit of significantly increasing the mechanical strength of the support. Moreover, the method used for forming the three-dimensional network is particularly useful, since applying the polymers in the form of an aqueous solution causes the first and second polymers to penetrate deep into, and around, the support fibers. The subsequent cross-linking reaction therefore holds the support fibers tightly within the three-dimensional network, thereby significantly increasing the mechanical strength of the sheet.

TABLE 7

| | Amount of | | Amount of | Chloro- | First | | Dry | Wet |
|---|---|---|---|---|---|---|---|---|
| | First | (N—H) | Second | hydrin | Polymer/ | Chloro- | Tensile | Tensile |
| | Polymer | group | Polymer | group | Second | hydrin/ | Strength | Strength |
| Sample | (g/m²) | (mmol) | (g/m²) | (mmol) | Polymer | (N—H) | (N/m) | (N/m) |
| 41 | 0 | 0 | 0 | 0 | 0 | 0 | 739 | 170 |
| 42 | 6.65 | 132.5 | 0.35 | 1.0 | 95/5 | 0.0075 | 2120 | 573 |
| 43 | 6.3 | 125.5 | 0.7 | 2.0 | 90/10 | 0.0159 | 2178 | 697 |
| 44 | 5.6 | 111.6 | 1.4 | 4.0 | 80/20 | 0.0358 | 2710 | 882 |
| 45 | 4.2 | 83.7 | 2.8 | 8.0 | 60/40 | 0.0956 | 2497 | 670 |
| 46 | 2.8 | 55.8 | 4.2 | 12.0 | 40/60 | 0.2150 | 2483 | 719 |

### Example 8

### Heat-Bonding

The handsheets described in Table 8 were impregnated with a solution obtained by mixing a polyethyleneimine having an average molecular weight 750,000 a.m.u. (Polymin® P from BASF) and a copolymer of epichlorohydrin and diallyl dimethyl ammonium chloride (poly[2-propen-1-aminium, N, N-dimethyl-N-2-propenyl-chloride]-co-[1-chloro-3-(di-2-propenylamino)-2-propanol hydrochloride] having an average molecular weight 40000 a.m.u. (PAS-880 from NITTOBO Japan) at a ratio of 65/35 in water and then adjusting the pH of the solution to pH 10 using sodium hydroxide solution 30% w/w). Impregnation of the nonwoven sheet was conducted by a padding technique (Mathis size-press at 1.8 bar of pressure) so that the total amount of the first and second polymers in the support was 5 g/m². The impregnated handsheets were dried on a hot plate at 110° C. for 2 minutes and subsequently cured in oven at 125° C. for 5 minutes.

In Table 8, the cellulosic-based heat sealable substrate was produced on a wetlaid industrial machine and is composed of 2 layers: a bottom layer and a heat sealable top layer. The bottom layer is composed of a blend of 67% softwood pulp Sodra Blue 90Z with 33% Viscose Danufil KS 1.7dtx 5 mm. The top layer is composed of a blend of softwood pulp and polyolefin fibers, wherein the polyolefin fibers melt when heated to enable heat-bonding.

The non-cellulosic heat sealable materials, in Table 8, are 30 and 60 g/m² PP spunbond (Grades WL25002 and WL25207 respectively from Ahlstrom), and 48 g/m² bicomponent core/sheath spunbond PET/co-PET (Grade WL25755 from Ahlstrom). As with Example 7, a wetting agent (FLUOWET from Clariant) was added at to the impregnating solution at a concentration of 0.5% w/w in order to assist the wetting and impregnation of the web.

As can be understood from Table 8, the presence of the three-dimensional network does not cause an intolerable drop in heat-sealing performance. Whilst there is a small drop in performance, the average seal strength and maximum seal strength values remain acceptable.

TABLE 8

| | | | | Sealing | | Average | Max | |
|---|---|---|---|---|---|---|---|---|
| | Nonwoven | | Sealing | dwell | Sealing | seal | seal | |
| | Support | Coverage | Temp. | time | pressure | strength | strength | Reason For |
| Sample | Composition | (g/m²) | (° C.) | (sec) | (psi) | (g/mm) | (g/mm) | Failure |
| 47 | Cellulosic 60 g/m² | Untreated | 200 | 3 | 15 | 514 | 638 | delamination |
| | heatseal substrate | 10.7 g/m² | | | | 460 | 607 | delamination |
| 48 | PP spunbond | Untreated | 190 | 0.5 | 15 | 628 | 1237 | Tear |
| | 30 g/m² WL25002 | 3.7 g/m² | | | | 394 | 547 | Tear |
| 49 | PP spunbond | Untreated | 195 | 0.5 | 15 | 348 | 548 | Tear |
| | 60 g/m² WL25207 | 5.9 g/m² | | | | 201 | 270 | Tear |
| 50 | Bico spunbond | Untreated | 170 | 0.5 | 15 | 1413 | 1620 | delamination |
| | 48 g/m² WL25755 | 4.2 g/m² | | | | 978 | 1096 | delamination |

### Example 9

### Average Molecular Weight of the First Polymer

Handsheets (50 g/m²) comprising 67% cellulose (softwood Sodra Blue 90Z) and 33% viscose (Kelheim Danufil KS 1.7dtx×8 mm) were impregnated with an epichlorohydrin modified polyamide (EMP) polymer (Giluton 1100-28N available from BK Giulini) and polyvinylamine (PVAm) having different average molecular weights having (Lupamin® 1595: <10 000 a.m.u.; Lupamin® 4595: 45 000 a.m.u.; Lupamin® 9095: 340 000 a.m.u., all >90% hydrolyzed, from BASF, Germany). The impregnation step was conducted by padding the support (using a Mathis size-press at 1.8 bar of pressure) with a solution obtained by mixing the polymers at the ratio described in Table 9, and then adjusting the pH of the solution to pH 10 using NaOH solution (30% w/w). The impregnated handsheets were dried on a hot plate at 110° C. for 2 minutes and subsequently cured in oven at 135° C. for 5 minutes. The resulting DPU values before (DPU₀) and after the washing test (DPU_{w}) are reported in Table 9.

TABLE 9

| | Average | | | | | | | | |
|---|---|---|---|---|---|---|---|---|---|
| | Molecular | Amount of | | Amount of | Chloro- | First | | | |
| | Weight (amu) | First | (N—H) | Second | hydrin | Polymer/ | Chloro- | | |
| | of First | Polymer | group | Polymer | group | Second | hydrin/ | DPU₀ | DPU_{w} |
| Sample | Polymer | (g/m²) | (mmol) | (g/m²) | (mmol) | Polymer | (N—H) | (mg) | (mg) |
| 51 | ≦10,000 | 4 | 88.4 | 0.44 | 1.45 | 90/10 | 0.017 | n.a.* | n.a.* |
| 52 | ≦10,000 | 4 | 88.4 | 2.67 | 8.91 | 60/40 | 0.101 | n.a.* | n.a.* |
| 53 | 45,000 | 4 | 88.4 | 0.44 | 1.45 | 90/10 | 0.017 | n.a.* | n.a.* |
| 54 | 45,000 | 4 | 88.4 | 2.67 | 8.91 | 60/40 | 0.101 | 40** | 38** |
| 55 | 340,000 | 4 | 88.4 | 0.44 | 1.45 | 90/10 | 0.017 | 75 | 76 |
| 56 | 340,000 | 4 | 88.4 | 2.67 | 8.91 | 60/40 | 0.101 | 43 | 43 |

*not significant value due to change in UV-Vis spectrum in the DPU testing solution;
**not significant value due to change in UV-Vis spectrum in the washing solution after dye addition.

### Example 10

### Comparative testing of Impregnation of Substrates with Different Polymer Solutions

The present technology, based on primary amine polymers as First Polymer, was compared to the use of different polymer solutions, as taught in US2003/0118730.

Experimental:—Nonwoven handsheets (50 g/m²) comprising 67% cellulose (softwood Sodra Blue 90Z) and 33% viscose (Kelheim Danufil KS 1.7dtx×8 mm) were impregnated with a formulation according to one embodiment of the present technology and compared with the results obtained by impregnating substrates with the corresponding formulations of US2003/0118730.

The impregnation step was conducted by padding the sheet (using a Mathis size-press at 1.8 bar of pressure). The handsheets were then dried on a hot plate at 110° C. for 2 minutes and then cured in a forced air oven at 135° C. for 5 minutes.

Table 10 gives the details of the formulations. Formulation #1 is a formulation of one embodiment of the present invention, #2 is a fully duplicate formulation of US2003/0118730—Example 1 (p. 13, Table 1).

TABLE 10

| Formulation # | % Active | #1 (% dry) | #2 (% dry) |
|---|---|---|---|
| PVAm | 21 | 86 | |
| Kymene | 13 | 5 | 23 |
| NaOH | 30 | 9 | |
| PVPVI | 30 | | 69.5 |
| PVNO | 40 | | 7.5 |

PVAm: polyvinylamine having an average molecular weight of 340,000 (wherein <10% of the amine groups are capped with formyl groups); Kymene: epichlorohydrin-modified polyamide polymer supplied by Ashland. PVPVI: Polyvinylpyrrolidone-co-vinylimidazole sold under the name of Sokalan HP 56 and supplied by BASF. PVNO: Polyvinylpyridine N oxide sold under the name of Reilline 4140 and supplied by Vertellus.

Results: Table 11 below shows the various experimental series performed with the testedw properties. Whiteness measurements were done according to the standard IS02470, Handle-o-meter measurements were done according the standard Tappi T498, and the Buchel rigidity was done according the standard BS3748.

TABLE 11

| Series | A | B | C |
|---|---|---|---|
| Formulation | #1 | #2 | #2 |
| Formulation dry | 8 | 24 | 13 |
| content (%) | | | |
| Initial viscosity | 27 | 73 | 20 |
| (mPa · s) | | | |
| Formulation dry | 7.6 | 22.4 | 7.5 |
| deposit g/m² | | | |
| Total basis weight | 54.4 | 69.5 | 53.9 |
| (g/m²) | | | |
| Whiteness (%) | 80 | 68 | 73 |
| Dry Tensile strength | 2247 | 3163 | 2204 |
| (N/m) | | | |
| Wet Tensile strength | 654 | 544 | 380 |
| (N/m) | | | |
| Ratio Wet/Dry tensile | 29 | 17 | 17 |
| strength (%) | | | |
| Handle-o-meter (cN) | 109 | >360 | 182 |
| Buchel rigidity (mN) | 64 | 202 | 106 |
| DPU₀ (mg) | 80 | 118 | 99 |
| DPU_{w} (mg) | 79 | 89 | 53 |

Series A corresponds to an embodiment of the present invention. Series B and C are duplicates of Example 1 formulation of US2003/0118730 with respectively 22.4 and 7.5 g/m² dry deposit on the nonwoven substrate. These deposit amounts are lower than the one given in (60 to 113 dry gsm).

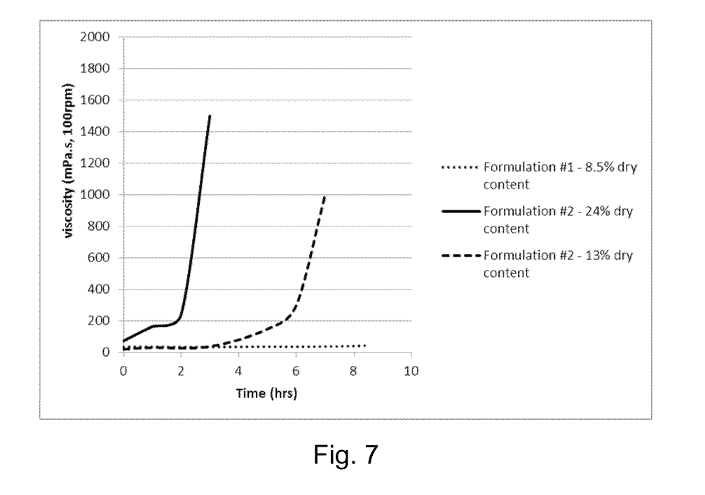

FIG. 7 shows the evolution of the solution viscosity with time for the studied formulations. The solution viscosity is measured using a Brookfield viscosimeter (model LVDE-E) equipped with a spindle type s61 at a rotational speed of 100 rpm and at a solution temperature of 22° C.

As will appear, the results obtained show that the use of a polymeric primary amine (Series A, present technology) gives rise to a more efficient cross-linking of the polymer components of the three-dimensional network entangled with the nonwoven substrate. In fact, Series A (with 5% of cross-linker) keeps its DPU performance after a washing step, whereas Series B and C (with 23% of cross-linker) is losing from 25 to 46% of its DPU efficiency after washing, indicating what appears to be a significant loss of the polymer material into the wash water. Thus, the known formulations do not lead to a fully (>90%) non water soluble treatment.

The low cross-linking efficiency of formulation #2 is also manifested in a low ratio of the wet to dry tensile strength: 17% compared to 29% for the present technology.

As far as processing is concerned, the testing showed that formulation #2 is rapidly increasing in viscosity making application in single step difficult. To solve this, US2003/0118730 teaches application in a 2-step process with a first application of the polymer and a second application of the cross-linker. This 2-step application even further reduces cross-linking efficiency. By contrast, the present technology (embodiment of formulation #1) provides a stable low viscosity over an 8 hr period of time which allows for a 1-step process.

In addition, the performance of an embodiment of the present technology (Series A), with a treatment amount of only 7.6 g/m² is equal to or even better than that achieved with a 3-times higher loading of the laundry aid articles of the art (the 22.4 g/m² of Series B).

As will be understood from the preceding description of the present invention and the illustrative experimental examples, the present invention can also be described by reference to the following embodiments:

1. A dye-capturing laundry aid comprising:
a support in the form of a sheet comprising water insoluble fibers; and
a three-dimensional network entangled with at least some of the fibers contained in the support, the three-dimensional network comprising a first polymer that is cross-linked by a second polymer; wherein:
the first polymer is a polyamine comprising primary amine groups, the first polymer being water soluble and cationic; and
the second polymer is a water soluble polymer that is different to the first polymer, the second polymer has repeating units comprising halohydrin and/or epoxide groups that are capable of forming covalent cross-links with the primary amine groups of the first polymer.

2. The laundry aid of embodiment 1, wherein titration of a pH 6.5 aqueous composition that has been obtained by immersing 50 g of the laundry aid in one liter of water at 70° C. for 10 minutes requires ≦3 mmol of NaOH to raise the pH of the aqueous composition from 6.5 to 10.5 at 25° C.

3. The dye-capturing laundry aid according to embodiment 1 or embodiment 2, wherein the halohydrin groups of the second polymer are chlorohydrin groups according to the following Formula (I):

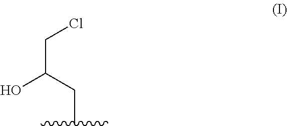 [SMILES: *CC(O)CCl]

4. The dye-capturing laundry aid according to any of embodiments 1-3, wherein the second polymer contains quaternary ammonium groups in the polymer.

5. The dye-capturing laundry aid according to any of embodiments 1-4, wherein the second polymer is a diallyl(3-chloro-2-hydroxypropyl)amine hydrochloride-diallyldimethylammonium chloride copolymer having the repeating units illustrated in following Formula (II):

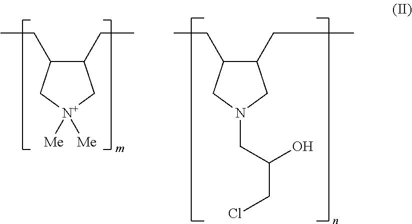

wherein the ratio of m:n in the polymer is in the range of from 1:9 to 9:1.

6. The dye-capturing laundry aid according to any of embodiments 1-5, wherein the average molecular weight of the second polymer in isolation is at least 1,000, preferably higher than 20,000.

7. The dye-capturing laundry aid according to any of embodiments 1-6, wherein the first polymer is at least one of poly(allyl amine), poly(ethylene imine), partially hydrolyzed poly(vinylformamide), polyvinylamide, chitosan and copolymers of the mentioned polyamines with any type of monomers.

8. The dye-capturing laundry aid according to any of embodiments 1-7, wherein the average molecular weight of the first polymer in isolation is at least 20,000, preferably higher than 100,000.

9. The dye-capturing laundry aid according to embodiment 7, wherein the first polymer in isolation comprises side-chains having quaternary ammonium groups.

10. The dye-capturing laundry aid according to embodiment 9, wherein the first polymer has side chains formed by grafting reacting the first polymer with glycidyl trimethylammonium chloride, 3-chloro-2-hydroxypropyl trimethylammonium chloride, or glycidyl trimethylammonium chloride and 3-chloro-2-hydroxypropyl trimethylammonium chloride both as grafting reactants.

11. The dye-capturing laundry aid according to any of embodiments 1-10, wherein the ratio by mass of the first polymer to the second polymer in the laundry aid is in the range of from 99:1 to 20:80, preferably from 97:3 to 50:50.

12. The dye-capturing laundry aid according to any of embodiments 1-11, wherein the fibers in the support comprise at least one of cellulose, viscose, lyocell, a polyalkene, a polyester, a poly(alkylene terephthalate) and copolymers thereof.

13. The dye-capturing laundry aid according to any of embodiments 1-12, wherein the fibers in the support comprise polyethylene, polypropylene, polyethylene terephthalate, polylactic acid or mixture or copolymer thereof.

14. The dye-capturing laundry aid according to any of embodiments 1-13, wherein the molecular ratio of the halohydrin and/or epoxide groups in the second polymer to the (N—H) functional groups in the first polymer is in the range of from 0.0035 to 0.0380.

15. The dye-capturing laundry aid according to any of embodiments 1-13, wherein the molecular ratio of the halohydrin and/or epoxide functional groups in the second polymer to the (N—H) functional groups in the first polymer is in the range of 0.0035 to 1.0000 and the second polymer also contains quaternary ammonium groups.

16. The dye-capturing laundry aid according to any of embodiments 1-13, wherein:
the first polymer is a polyvinylamine-based polymer having an average molecular weight in the range of 100,000 and 750,000;
the second polymer is an epichlorohydrin-modified polyamide having an average molecular weight in the range of from 5,000 to 100,000;
the mass ratio of the first and second polymers is in the range of from 97:3 to 50:50, for example 97:3 to 75:25; and
optionally wherein the ratio of chlorohydrin groups to the N—H groups between the second and first polymers is in the range of from 0.0035 to 0.0380.

17. The dye-capturing laundry aid according to any of embodiments 1-13, wherein:
the first polymer is a polyethyleneimine having an average molecular weight in the range of 100,000 and 1,000,000;
the second polymer is a polymer having both quaternary ammonium groups and epichlorohydrin groups and has an average molecular weight in the range of from 5,000 to 200,000;
the mass ratio of the first and second polymers is in the range of from 97:3 to 50:50; and
optionally wherein the ratio of chlorohydrin groups to the N—H groups between the second and first polymers is in the range of from 0.0035 to 1.0000.

18. The dye-capturing laundry aid according to any of embodiments 1-13, wherein:
the first polymer is a polyallylamine comprising quaternary ammonium groups and has an average molecular weight in the range of 100,000 and 1,000,000;
the second polymer is a polymer having both quaternary ammonium groups and epichlorohydrin groups and has an average molecular weight in the range of from 5,000 to 200,000;
the mass ratio of the first and second polymers is in the range of from 97:3 to 50:50, for example 97:3 to 75:25, and
optionally wherein the ratio of chlorohydrin groups to the N—H groups between the second and first polymers is in the range of from 0.0035 to 0.0380.

19. The dye-capturing laundry aid according to any of embodiments 1-18, wherein the fibrous support comprises a heat-sealable component in at least a portion of the support.

20. The dye-capturing laundry aid according to any of embodiments 1-19, wherein the laundry aid forms a porous envelope surrounding an inner chamber.

21. The dye-capturing laundry aid according to any of embodiments 1-20, wherein the three-dimensional network has a basis weight of 1.0 to 20.0 g/m², for example 1 to 15 g/m², in particular 1 to 10 g/m².

22. The dye-capturing laundry aid according to any of embodiments 1-21, wherein the the content of the second polymer is 1 to 20 weight-% calculated from the dry mass of the three-dimensional network.

23. A process of producing a dye-capturing laundry aid as defined in any of embodiments 1-22, comprising:
(i) sequentially or simultaneously impregnating the fiber-containing support with the first polymer and the second polymer; and
(ii) cross-linking the first polymer with the second polymer in the support to form a three-dimensional network of cross-linked first and second polymers.

24. The dye-capturing laundry aid according to any of embodiments 1-21, wherein the laundry aid is obtainable by a process as defined in embodiment 23.

25. Use of a dye-capturing laundry aid as defined in any of embodiments 1-22 or 24 to scavenge a dye or dyes from an aqueous medium.

1. A dye-capturing laundry aid comprising:
a support in the form of a sheet comprising water insoluble fibers; and
a three-dimensional network entangled with at least some of the fibers contained in the support, the three-dimensional network comprising a first polymer that is cross-linked by a second polymer; wherein:
the first polymer is a polyamine comprising primary amine groups, the first polymer being water soluble and cationic; and
the second polymer is a water soluble polymer that is different from the first polymer, the second polymer comprising repeating units comprising halohydrin and/or epoxide groups that are capable of forming covalent cross-links with the primary amine groups of the first polymer; and
optionally wherein titration of a pH 6.5 aqueous composition that has been obtained by immersing 50 g of the laundry aid in one liter of water at 70° for 10 minutes requires ≦3 mmol of NaOH to raise the pH of the aqueous composition from 6.5 to 10.5 at 25° C.

2. The dye-capturing laundry aid according to claim 1, wherein the halohydrin groups of the second polymer are chlorohydrin groups according to the following Formula (I):

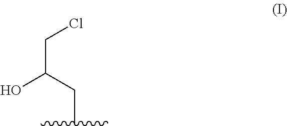 [SMILES: *CC(O)CCl]

3. The dye-capturing laundry aid according to claim 1, wherein the second polymer contains quaternary ammonium groups in the polymer.

4. The dye-capturing laundry aid according to claim 2, wherein the second polymer is a diallyl(3-chloro-2-hydroxypropyl)amine hydrochloride-diallyldimethylammonium chloride copolymer having the repeating units illustrated in following Formula (II): 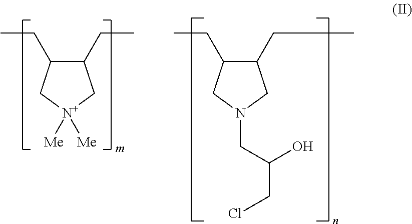
wherein the ratio of m:n in the polymer is in the range of from 1:9 to 9:1.

5. The dye-capturing laundry aid according to claim 1, wherein the average molecular weight of the second polymer in isolation is at least 1,000, preferably higher than 20,000.

6. The dye-capturing laundry aid according claim 1, wherein the first polymer is at least one of poly(allyl amine), poly(ethylene imine), partially hydrolyzed poly(vinylformamide), polyvinylamide, chitosan and copolymers of the mentioned polyamines with any type of monomers.

7. The dye-capturing laundry aid according claim 1, wherein the average molecular weight of the first polymer in isolation is at least 20,000, preferably higher than 100,000.

8. The dye-capturing laundry aid according to claim 6, wherein the first polymer in isolation comprises side-chains having quaternary ammonium groups.

9. The dye-capturing laundry aid according to claim 8, wherein the first polymer has side chains formed by grafting reacting the first polymer with glicidyl trimethylammonium chloride and/or 3-chloro-2-hydroxypropyl trimethylammonium chloride as grafting reactants.

10. The dye-capturing laundry aid according to claim 1, wherein the fibers in the support comprise at least one of cellulose, viscose, lyocell, a polyalkene, a polyester, a poly(alkylene terephthalate) and copolymers thereof.

11. The dye-capturing laundry aid according to claim 1, wherein the fibers in the support comprise polyethylene, polypropylene, polyethylene terephthalate, polylactic acid, or a mixture or a copolymer thereof.

12. The dye-capturing laundry aid according to claim 1, wherein the fibrous support comprises a heat-sealable component in at least a portion of the support.

13. The dye-capturing laundry aid according to claim 1, wherein the laundry aid forms a porous envelope surrounding an inner chamber.

14. The dye-capturing laundry aid according to claim 1, wherein the three-dimensional network has a weight of 1.0 to 20.0 g/m², for example 1 to 15 g/m², in particular 1 to 10 g/m².

15. The dye-capturing laundry aid according to claim 1, wherein the content of the second polymer is 1 to 20 weight-% calculated from the dry mass of the three-dimensional network.

16. A process of producing a dye-capturing laundry aid as defined in claim 1, comprising:
(i) sequentially or simultaneously impregnating the fiber-containing support with the first polymer and the second polymer; and
(ii) cross-linking the first polymer with the second polymer in the support to form the three-dimensional network of cross-linked first and second polymers.

17. The dye-capturing laundry aid which is obtainable by a process as defined in claim 16.

18. Use of a dye-capturing laundry aid as defined in claim 1 to scavenge a dye or dyes from an aqueous medium.
